(19) United States
(12) Patent Application Publication
(10) Pub. No.: US 2024/0221312 A1
(43) Pub. Date: Jul. 4, 2024

(54) Systems and methods for generating and/or using 3-dimensional information with one or more cameras

(71) Applicant: Visionary Machines Pty Ltd, Sydney (AU)

(72) Inventor: Rhys Andrew Newman, Sydney (AU)

(73) Assignee: Visionary Machines Pty Ltd, Sydney (AU)

(21) Appl. No.: 18/558,058

(22) PCT Filed: Apr. 30, 2022
(86) PCT No.: PCT/AU2022/050403

§ 371 Date: Oct. 30, 2023

(30) Foreign Application Priority Data
Apr. 30, 2021 (AU) 2021901292

(51) Int. Cl. G06T 17/05; G06T 7/20; G06V 10/46

(52) U.S. Cl. CPC G06T 17/05; G06T 7/20; G06V 10/46

(57) ABSTRACT

The present disclosure is directed to devices, systems and/or methods that may be used for determining scene information from a real-life scene using data obtained at least in part from one or more cameras that may move within, over or past a real-life scene. In certain embodiments, some of the cameras may be substantially stationary. Exemplary systems may be configured to generate three-dimensional information in real-time, or substantially real time, and may be used to estimate velocity of one or more physical surfaces in the real-life scene.

### TECHNICAL FIELD

The present disclosure relates generally to devices, systems and/or methods that may be used for determining scene information using data obtained at least in part from one or more cameras. That scene information may be 3D information.

### BACKGROUND

Scene information about the 3D environment is useful for many applications including, for example, the safe autonomous driving of vehicles on conventional roads and highways, and for example for navigation, surveying, environmental monitoring, crop monitoring, mine surveying, and checking the integrity of built structures.

One way of creating such scene information is with devices that use one or more lasers, potentially strobing to cover a scene, to emit pulses of light and by measuring the time delay to receive reflected pulses determine the distances of surfaces in the 3D scene from the laser source—such devices are commonly termed LiDAR. This approach has a number of drawbacks, for example: (1) it is difficult to achieve lateral accuracy at long range (angular resolution is fixed and therefore errors grow with distance); (2) the laser pulses potentially interfere when there are many active lasers in an environment (a common case in traffic filled with LiDAR equipped vehicles); (3) the returned pulses require reasonable reflectivity from the target physical surface in the response direction, and (4) rain, dust and snow cause difficulties by cluttering the scene with potential multiple reflections that break the assumption that the light pulses travel to a target and back in a straight line. Further, LiDAR does not capture the visual appearance (typically contained in the Red-Green-Blue (RGB) part of the visual electromagnetic spectrum) of the target physical surface, thereby limiting some processing and analysis.

Another way to create 3D scene information is to use radar. However, radar is more limited in angular resolution than LiDAR, and reflections are more dependent on target physical surface characteristics; e.g., metal reflects well but human bodies absorb most of the radar signal.

Optical camera systems may be used, with appropriate processing, to generate 3D scene information. Binocular cameras, capturing pairs of images may be used to derive 3D scene information, in particular, depth information, based on binocular disparity (i.e., the difference between the positions in two images of a fixed feature in the scene). Typically, binocular disparity methods match local regions in image pairs captured by cameras that have a known physical separation or baseline. From the disparity, a depth for the matched region may be determined based on optical (the assumption that light travels in straight lines) and geometric triangulation principles. Binocular disparity methods are prone to error in plain regions where there is little or no texture for identifying accurate matches between the two separate views. Binocular disparity methods also suffer from ambiguity around objects whose parts are occluded from one or both cameras.

Optical camera systems that use more than two cameras in concert to view a scene from different positions are known in the art; these systems are often simply referred to as camera arrays. These arrays capture a set of 2D images of the scene from multiple different directions and/or positions. Depth information may then be obtained using similar principles to the binocular camera, based on the disparity of local image regions matched between pairs of images from different cameras in the camera array. One implementation of a camera array system is the micro-lens array; i.e., an array of small lenses set in a fixed grid positioned in front of miniature individual camera sensors. However, the baseline between camera pairs in such an array is typically constrained by the size and resolution of the fabrication process (making the baselines very small), therefore limiting both depth and angular resolution and accuracy.

Another approach is to use cameras mounted on a platform that moves within a scene (e.g., a vehicle) and collect a series of images from the cameras over time. These images may consequently represent views of the scene from positions between which the baselines may be defined, at least in part, by the distance moved by the vehicle over a period of time during which the images are captured.

Previous systems that take these approaches may generate large volumes of data that must be then managed (often millions of pixel values per camera per second), and which may require significant computational resources to determine from them accurate depth and other desired scene information. In one approach the mapping between sample points in a three-dimensional space and their appearance in each camera's field of view may need to be determined for each camera individually and adjusted for motion over multiple image “frames” taken over a period of time. The number of such sample points may be very large if required to cover a substantial portion of the scene at a high resolution. The mapping between the sample points in the scene and pixels in the image data from the cameras for each frame, which with current technology may easily be captured at over 60 frames/second, conventionally requires a large amount of computational resources. If a substantial fraction of these images is used to estimate 3D scene information the total computational effort may become infeasible to achieve at acceptable frame rate. Consequently, such systems often operate with a constrained resolution or with limited frame rate. It might be thought that the mapping between the sample points and the pixels in the image data may be precomputed (i.e., once during manufacturing or once at system start time) to save computational effort. However, in this case the number of parameters that must be stored in computer memory, and then applied to transform the image data, may be large and therefore impractical to build or operate at real-time speeds. In any case the high computational requirements or the high number of parameters needed to be stored make it difficult to construct a system that may deliver accurate, high resolution 3D scene information at suitable real time frame rates.

The present disclosure is directed to overcome and/or ameliorate at least one or more of the disadvantages of the prior art, as will become apparent from the discussion herein. The present disclosure also provides other advantages and/or improvements as discussed herein.

### SUMMARY OF THE DISCLOSURE

Certain embodiments of the present disclosure are directed to devices, systems and/or methods that may be used for determining scene information using data obtained at least in part from one or more cameras that move within a scene. That scene information may be 3D information.

In certain embodiments, the system may be configured to generate three-dimensional information in real-time or substantially real time.

In certain embodiments, the system may be configured to generate three-dimensional information at real-time frame rates or substantially real-time frame rates.

Certain embodiments are directed to methods for generating three-dimensional video information using one or more of the exemplary disclosed systems.

Certain embodiments are directed to systems that may be used to estimate the velocity of physical surfaces in a real-life scene.

Certain embodiments of the present disclosure are directed to a system for generating three-dimensional information of a scene comprising: one or more cameras, the one or more cameras configured to be positioned to view the scene, and the one or more cameras configured to generate pixel data representative of at least two images taken at different positions relative to the scene; the one or more cameras configured to transmit pixel data associated at least in part with at least two images to one or more computer systems; and the one or more computer systems configured to: obtain the associated pixel data from the at least two images; and use at least a portion of the associated pixel data to determine the likely position of one or more physical surfaces in the scene.

Certain embodiments of the present disclosure are directed to a system for generating three-dimensional information of a scene comprising: one or more cameras, the one or more cameras configured to be positioned to view the scene, and the one or more cameras configured to generate pixel data representative of at least two images taken at different positions relative to the scene; the one or more cameras configured to transmit pixel data associated at least in part with the least two images to one or more computer systems; and the one or more computer systems configured to: obtain the transmitted associated pixel data from the at least two images; extract at least a portion of the associated pixel data; use the at least a portion of the associated pixel data to generate a representation of a 3D neighbourhood that is representative of at least a portion of the scene based at least in part on the projection of the 3D neighbourhood in at least one of the images; and use the at least a portion of the associated pixel data to determine the likelihood one or more physical surfaces in the scene intersects the 3D neighbourhood.

Certain embodiments of the present disclosure are directed to a system for generating three-dimensional information of a scene comprising: one or more cameras, the one or more cameras configured to be positioned to view the scene, and the one or more cameras configured to generate pixel data representative of at least two images taken at different positions relative to the scene; the one or more cameras configured to transmit pixel data associated at least in part with the at least two images to one or more computer systems; and the one or more computer systems configured to: obtain the transmitted pixel data; use at least portion of the pixel data to generate one or more representations of one or more 3D neighbourhoods that are representative of at least in part of a portion of the scene; and use the one or more representations to determine a likelihood that the one or more 3D neighbourhoods contain at least one physical surface from the scene.

Certain embodiments of the present disclosure are directed to a method for generating three-dimensional information of a scene comprising: generating at least two images taken at different positions relative to the scene with one or more cameras, the one or more cameras positioned to view the scene, and generating pixel data representative of the at least two images taken at different positions relative to the scene with the one or more cameras; transmitting pixel data associated at least in part with the at least two images from the one or more cameras to one or more computer systems; receiving at the one or more computer systems the associated pixel data from the at least two images; and using at least a portion of the associated pixel data to determine the likely position of one or more physical surfaces in the scene.

Certain embodiments of the present disclosure are directed to a method for generating three-dimensional information of a scene comprising: generating pixel data representative of at least two images taken at different positions relative to the scene with one or more cameras, the one or more cameras being positioned to view the scene; transmiting pixel data associated at least in part with the least two images from the one or more cameras to one or more computer systems; obtaining the transmitted associated pixel data from the at least two images at the one or more computer systems; extracting at least a portion of the associated pixel data at the one or more computer systems; using the at least a portion of the associated pixel data to generate a representation of a 3D neighbourhood that is representative of at least a portion of the scene based at least in part on the projection of the 3D neighbourhood in at least one of the images; and using the at least a portion of the associated pixel data to determine the likelihood one or more physical surfaces in the scene intersects the 3D neighbourhood.

Certain embodiments of the present disclosure are directed to a method for generating three-dimensional information of a scene comprising: generating pixel data representative of at least two images taken at different positions relative to the scene with one or more cameras, the one or more cameras being positioned to view the scene; transmitting pixel data associated at least in part with the at least two images from the one or more cameras to one or more computer systems; obtaining the transmitted pixel data at the one or more computer systems; using at least portion of the pixel data to generate one or more representations of one or more 3D neighbourhoods that are representative of at least in part of a portion of the scene; and using the one or more representations to determine a likelihood that the one or more 3D neighbourhoods contain at least one physical surface from the scene.

Certain embodiments of the present disclosure are to methods of using the systems disclosed herein.

### BRIEF DESCRIPTION OF DRAWINGS

FIG. 1 shows a top-level system diagram for creating a 3-dimensional representation of a scene, including a camera platform and a computer system, according to certain embodiments.

FIG. 2 shows a schematic component diagram for a camera, according to certain embodiments.

FIG. 3 is an illustration of an exemplary real-world scene observed by 1-4 cameras and showing a reference surface which is in this case a fronto-parallel plane.

FIG. 4 is an illustration of alternative placements of a reference surface.

FIG. 5 is an illustration of an epipolar plane and epipolar lines for an image pair.

FIG. 6 is an illustration of an epipolar rectification for an image pair.

FIG. 7 is an illustration of a geometric construction for creating consistent depth shift warps for an image pair.

FIG. 8 is an illustration of a pair of warps in relation to a pair of source images.

FIG. 9 is an illustration of a geometric construction for creating consistent depth shift warps for an image pair using a curved reference surface.

FIG. 10 is an illustration of exemplary uses and possible camera configurations, according to certain embodiments.

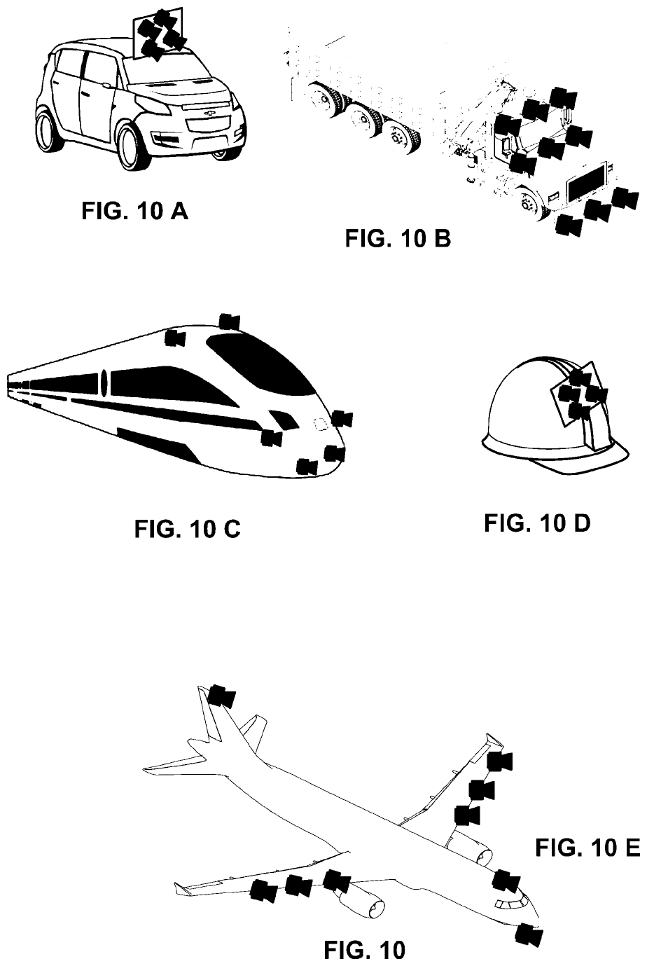

FIG. 11 is an illustration of further exemplary camera configurations, according to certain embodiments.

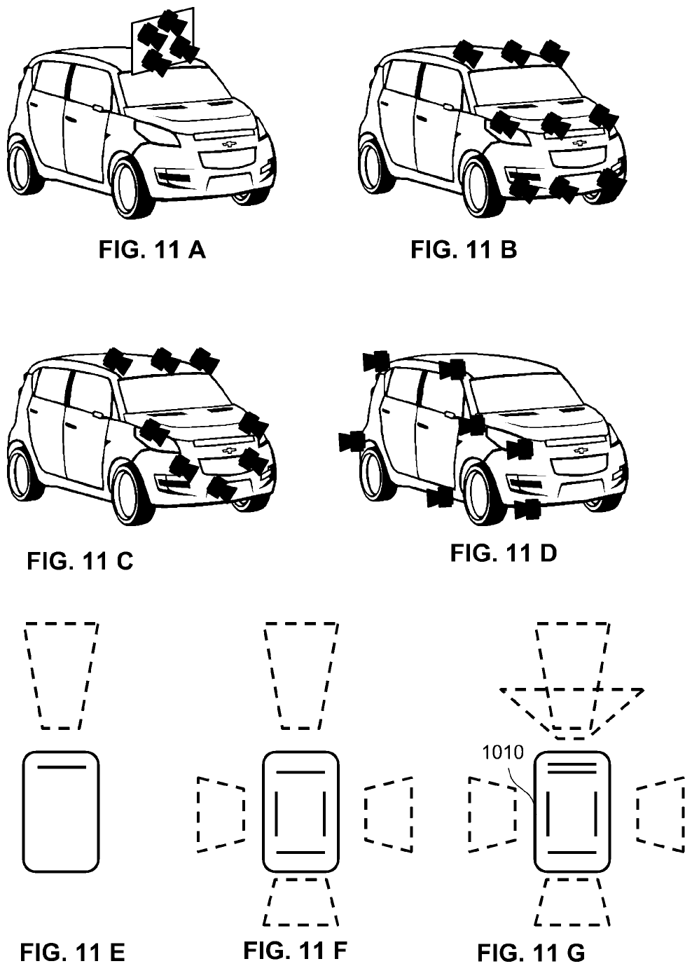

FIG. 12 is an illustration of exemplary camera configurations, according to certain embodiments.

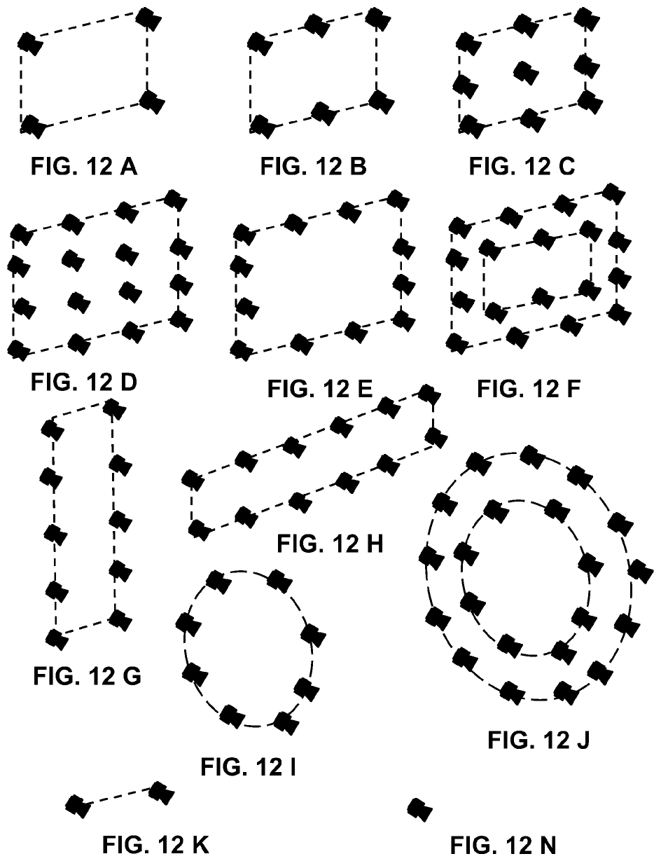

FIG. 13 shows a flow chart of an exemplary process.

FIG. 14 is an illustration of a cost matrix.

FIG. 15 is an illustration of Compensation of Optical Flow process.

FIG. 16 shows a flow chart of an alternative exemplary process.

FIG. 17 shows a flow chart of an alternative exemplary process.

FIG. 18 is an illustration of how 3D neighbourhoods are constructed.

FIG. 19 is an illustration of exemplary camera array where at least one camera is moving and at least one camera is stationary, according to certain embodiments.

### DETAILED DESCRIPTION

The following description is provided in relation to several embodiments that may share common characteristics and features. It is to be understood that one or more features of one embodiment may be combined with one or more features of other embodiments. In addition, a single feature or combination of features in certain of the embodiments may constitute additional embodiments. Specific structural and functional details disclosed herein are not to be interpreted as limiting, but merely as a representative basis for teaching one skilled in the art to variously employ the disclosed embodiments and variations of those embodiments.

The subject headings used in the detailed description are included only for the ease of reference of the reader and should not be used to limit the subject matter found throughout the disclosure or the claims. The subject headings should not be used in construing the scope of the claims or the claim limitations.

Certain embodiments of this disclosure may be useful in a number of areas. For example, one or more of the following non-limiting exemplary applications: off-road vehicles (e.g., cars, buses, motorcycles, trucks, tractors, forklifts, cranes, backhoes, bulldozers); road vehicles (e.g., cars, buses, motorcycles, trucks); rail based vehicles (e.g., locomotives); air based vehicles (e.g., airplanes), space based vehicles (e.g., satellites, or constellations of satellites); individuals (e.g., miners, soldiers, war fighters, rescuers, maintenance workers), amphibious vehicles (e.g., boats, cars, buses); and watercraft (e.g., ships boats, hovercraft, submarines). In addition, the non-limiting exemplary applications may be operator driven, semi-autonomous and/or autonomous.

The term “scene” means a subset of the three dimensional real-world (i.e., 3D physical reality) as perceived through the field of view of one or more cameras. In certain embodiments, there may be at least 1, 2, 3, 4, 5, 10, 15, 20, 25, 30, 35 or 40, 100, 1000, or more cameras. In certain embodiments, there may be between 2 and 4, 2 and 8, 4 and 16, 16 and 128, 128 and 1024 cameras.

The term “object” means an element in a scene. For example, a scene may include one or more of the following objects: a person, a child, a car, a truck, a crane, a mining truck, a bus, a train, a tank, a military vehicle, a ship, a speedboat, a vessel, a cargo ship, a naval ship, a motorcycle, a wheel, a patch of grass, a bush, a tree, a branch, a leaf, a rock, a hill, a cliff, a river, a road, a marking on the road, a depression in a road surface, a snow flake, a house, an office building, an industrial building, a tower, a bridge, an aqueduct, a bird, a flying bird, a runway, an airplane, a drone, a missile, a helicopter, door, a door knob, a shelf, a storage rack, a fork lift, a box, a building, an airfield, a town or city, a river, a mountain range, a field, a jungle, and a container. An object may be a moving element or may be stationary or substantially stationary. An object may be considered to be in a background or a foreground.

The term “physical surface” means the surface of an object in a scene that emits and/or reflects electromagnetic signals in at least one portion of the electromagnetic spectrum and where at least a portion of such signals travel across at least a portion of the scene.

The term “3D point” means physical location of a point in a scene defined at least in part by at least three parameters that indicate distance in three dimensions from an origin reference to the point, for example, in three directions from the origin where the directions may be substantially perpendicular (at least not co-planar or co-linear), or as an alternative example using a spherical coordinate system consisting of a radial distance, a polar angle, and an azimuthal angle. The term “representative 3D point” means a digital representation of a location of an actual point in a scene.

The terms “3D neighbourhood” or “neighbourhood” means a physical 3D volume in a scene whose maximum linear extent in one or more directions may be limited to be less than a specified threshold. That threshold, which may be different for different directions, may be, for example, 0.1 mm, 1 mm, 5 mm, 1 cm, 5 cm, 10 cm, 50 cm, 1 m, 5 m, 10 m, 50 m, 100 m, or other value of appropriate scale when considering the overall size of the physical space represented by a scene. A 3D neighbourhood may be considered to contain one or more 3D points if the coordinates of those 3D points lie within the 3D volume described by that 3D neighbourhood. Discussion and/or calculations that refer to 3D neighbourhoods in the present disclosure may also apply to single 3D points. The terms “representative 3D neighbourhood” or “representative neighbourhood” means a digital representation of a 3D volume in a scene.

The terms “3D scene information”, “3D information” or “scene information” mean information about a scene during a relatively static time period, where information about one or more 3D points, 3D neighbourhoods and/or scene information in the scene may optionally include none or one or more of: i) a characteristic location of the 3D neighbourhood (non-limiting examples may be the arithmetic or geometric centroid of the 3D points contained in the neighbourhood); ii) the spectral information regarding the appearance of one or more 3D points, objects or physical surfaces at least partially contained in the 3D neighbourhood from the viewpoint of one or more cameras; iii) a set of data that describe, at least in part, the 3D points, objects or physical surfaces at least partially contained in the 3D neighbourhood; and iv) data that describe, at least in part, attributes of the 3D neighbourhood that are may be used for computing the likely presence and/or characteristics of physical surfaces that may at least partially be contained in the 3D neighbourhood or may be useful for subsequent processing and/or decision making systems. The set of data may include one or more of the following properties: the texture of the 3D points; spectral data from a region near the 3D points; the instantaneous velocities of one or more 3D points in one, two, or three dimensions (also allowing for one or more summarized velocity values such as the average velocity of the 3D points in one, two, or three dimensions); the type or classification of an object or physical surface wholly or partially present in the 3D neighbourhood; and other data.

The term “3D velocity data” means the velocity components of the at least a portion of the 3D scene information.

The term “sensor element” means a device that measures the intensity of the incoming electromagnetic spectrum arriving on its surface over a controllable period of time.

The term “image sensor” means a plurality of sensor elements arranged spatially. The plurality of sensor elements may be arranged in a planar, or substantially planar, relationship. The plurality of sensor elements may be arranged in a substantially regular pattern (for example, the sensor elements may be substantially equally spaced apart). The plurality of sensor elements may be arranged in an irregularly spaced pattern (for example, the sensor elements may be spaced apart at different distances). The plurality of sensor elements may be arranged regularly and irregularly spaced pattern (for example, at least two sensor elements may be substantially equally spaced apart and at least two sensor elements may be spaced apart at different distances substantially equally spaced apart). The sensor elements may be arranged in at least 1, 2, 3, or 4 planar, or substantially planar, relationships. Other spatial relationships of the sensor elements within an image sensor are contemplated.

The term “filter array” means a filter, or a set of filters, that are positioned in proximity to the sensor elements in an image sensor such that the filter, or the set of filters, limits the electromagnetic spectrum reaching sensor elements to a limited frequency range, so the sensor element(s) respond(s) to and measure(s) the intensity of substantially that part of the spectrum. A non-limiting example of a filter array is a Bayer filter which filters light in an RG-GB pattern across groups of 4 neighbouring sensor elements that are arranged in a 2×2 rectangular grid. Another non-limiting example is a filter that may restrict the frequencies of light to a substantial portion of the sensor elements.

The term “camera” means a device that comprises an image sensor, an optional filter array and a lens (or a plurality of lenses) that at least partially directs a potentially limited portion of incoming electromagnetic signals onto at least some of the sensor elements in the image sensor. The lens, for example, may be an optical lens, a diffraction grating or combinations thereof.

The term “image” means the data captured by the image sensor of a particular camera at a given time or over a specified time period. An image may also mean data that may comprise at least in part computational transformations of other data where there may be an advantage to store the transformed data in a manner mappable to a two-dimensional grid evocative of an image-like structure. Non-limiting examples include one or more of the following: filtered image data, rectified image data, optical flow data, subsampled image data, transparency data, projections of 3D points onto 2D surfaces, projections of 3D neighbourhoods onto 2D surfaces, and projections of higher-dimensional data onto 2D surfaces or grids.

The term “image plane” means the 2-D surface of the image sensor, a representation of the 2-D surface of the image sensor in data, or a 2D mathematical geometrical construct used for pedagogical convenience (a non-limiting example may be a 2D surface onto which a mathematical projection of higher dimensional data may be constructed). Examples of such higher-dimensional data may include one or more of the following: 3D points, 3D neighbourhoods, 3D points that include colour with 3 channels (RGB—thus being 6D), and 3D points that have associated at least RGB colour channel data and at least one velocity measurement out of the 3 independent spacial directions (thus being up to 9D).

The term “camera centre” or “camera optical centre” as used herein means the abstract 3D point at which directed rays of the electromagnetic spectrum that enter the camera from sources in the scene would intersect if they could pass through filter arrays, lens(es) and/or sensor elements of the image sensor in straight lines without impediment.

The term “each” as used herein means that at least 95%, 96%, 97%, 98%, 99% or 100% of the items or functions referred to perform as indicated. Exemplary items or functions include, but are not limited to, one or more of the following: location(s), image(s), image pair(s), cell(s), pixel(s), pixel location(s), layer(s), element(s), representative neighbourhoods, neighbourhood(s), point(s), representative 3D neighbourhood(s), 3D neighbourhood(s), surface(s), physical surface(s), representative 3D point(s), and 3D point(s).

The term “horizontal” in reference to image data may be used for convenience in referring to orientation. For example, in conventional terms image data may be considered to be arranged in horizontal scanlines. In practice the orientation of image data may be equally valid to be considered vertical, or be along rows of pixels, or be along columns of pixels, or be arranged along lines or curves (including discontinuous lines or curves) that have been chosen for computational, implementational or pedagogical convenience. The term “horizontal” may be understood to refer to a nominally horizontal orientation that may in fact be 5%, 10%, or 20%, or more off a strictly horizontal orientation.

The term “at least a substantial portion” as used herein means that at least 60%, 70%, 80%, 85%, 95%, 96%, 97%, 98%, 99%, or 100% of the items or functions referred to. Exemplary items or functions include, but are not limited to, one or more of the following: location(s), image(s), image pair(s), cell(s), pixel(s), pixel location(s), layer(s), element(s), point(s), neighbourhood(s), representative neighbourhoods, surface(s), physical surface(s), 3D neighbourhood(s), representative 3D neighbourhood(s), representative 3D point(s), and 3D point(s).

The term “spectral data” means the data representing electromagnetic signal's measured intensity produced from a selected plurality of sensor elements in an image sensor where the sensor elements, optionally assisted by a filter array, measure incoming intensity in a plurality of portions of the electromagnetic spectrum. One example of spectral data may be colour. Colour may be represented by the strength of electromagnetic signals in red, green and blue bands of visible light in the electromagnetic spectrum where filters are arranged in a Bayer pattern of RG-GB or similar. Alternative systems may also use non-visible bands in the electromagnetic spectrum or alternative bands in the visible spectrum. Further the spectral data may mean the collected output of a pre-determined number of sensor elements, at least a substantial portion configured to respond to at least one portion of the electromagnetic spectrum and may include those that sample multiple potions of the electromagnetic spectrum.

The term “optical flow data” means data describing the apparent local movement of the 2D image across the image plane at one or more locations in the image.

The term “pixel” means one of a plurality of data storage elements that have a two-dimensional neighbourhood relationship to each other that make them collectively mappable onto a two-dimensional grid. A pixel may contain electromagnetic spectral data sampled at a particular time from a sensor element that may be part of an image sensor. A pixel may also contain the results of computational transformations of other data where there may be an advantage to store the transformed data in a manner mappable to a two-dimensional grid (for example, filtered image data, rectified image data, optical flow data, uncertainty bounds, transparency data).

The term “pixel data” or “pixel-level data” means one or more of the spectral data and/or the optical flow data sensed (for example, by a camera) or computed at a pixel location, and/or data derived from the spectral data and/or data derived from the optical flow data and/or data derived from other data associated with the pixel location.

The term “relatively static time period” means a period of time during which the substantial majority of the physical surfaces and/or objects in a scene are at least substantially stationary relative to one another and during which one or more cameras may move through, over or past the physical surfaces and/or objects in the scene. As used with respect to this term, the period of time may be about 0.0001 seconds, 0.01 seconds, 0.05 seconds, 0.1 seconds, 0.2 seconds, 1 second, or 10 seconds, in certain embodiments. As used with respect to this term, in certain embodiments the period of time may be less than 0.0001 seconds, 0.01, 0.05, 0.1 seconds, 0.2 seconds, 1 second, 10 seconds or longer if appropriate to the situation. As used with respect to this term, in certain embodiments, the period of time may be between 0.0001 seconds and 10 seconds, 0.0001 seconds and 0.01 seconds, 0.01 seconds and 1 second, 0.05 seconds and 5 seconds, 0.1 seconds and 1 second, 0.2 seconds and 2 seconds, 1 second and 4 seconds, or 0.1 seconds and 10 seconds, or larger ranges as appropriate to the situation. As used with respect to this term, the period may be 1 minute, 10 minutes, 100 minutes or longer as appropriate when distances in the scene and/or speeds of objects or cameras are of an appropriate scale for the application (for example in satellite and/or space-based applications). As used with respect to this term, the substantial majority may be at least 70%, 80%, 85%, 90%, 95% or 100% of the physical surfaces in the scene. As used with respect to this term, the phrase “substantially stationary” means the physical surfaces' movements relative to each other may be less than 0.1%, 0.2%, 0.5%, 1%, 2%, 5% or 10% of their positions relative to each other, or greater if appropriate to the situation.

The term “sequential frames” means the set of images (for example, 2, 3, 4, 6, 9, 16, 20, 32, 64 or other number) taken by one or more cameras of a plurality of cameras within a relatively static time period, but may be taken with some time delay between which one or more cameras move within the scene. The set of images taken by one or more cameras of a plurality of cameras within a relatively static time period may be at least 2, 3, 4, 6, 9, 16, 20, 32, 64, or more if appropriate to the situation.

The term “geometric median” means a point constructed to be in a position within a multi-dimensional space amongst a set of data points in that space in such a way that the sum of Euclidean distances to a portion of data points from the geometric median point thus constructed may be mathematically minimised. In certain embodiments, the portion of data points may be a substantial portion. In certain embodiments, the portion of data points may be at least 60%, 70%, 80%, 90%, 95%, 98%, 99% or 100% of the data points.

The term “baseline” means the non-zero distance between the optical centre of a camera used to capture at least one first image and the optical centre of a camera used to capture at least one second image. The camera used to capture the at least one first image may be the same, or substantially the same, as the camera used to capture the at least one second image, where the camera has moved some distance between capture of the at least one first image and capture of the at least one second image.

The term “disparity” means the mathematical difference between the pixel location in one image (relative to a fixed origin pixel location in that image) of a feature in a scene, and the pixel location in a second image (relative to a fixed origin pixel location in the second image) of that same feature.

The term “binocular” means forming or using a pair of images captured from two physically separate 3D positions. This may be done with more than one camera (for example, a camera pair) separated by a baseline, or one camera taking two or more images separated in time while it moves within, over or past the scene while maintaining a substantial portion of the scene within its field of view, or a combination of these approaches.

The term “overlapping fields of view” means that at least 5%, 10%, 20%, 30%, 40%, 50%, or 60% of the fields of view of one or more cameras, even when moved during a relatively static time period, overlap. In certain embodiments, at least 25%, 50%, 75%, or 100% of the one or more cameras have overlapping fields of view. In certain embodiments, there may be at least 1, 2, 3, 4, 5, 6, 7, 8, 9, 10, 20, 50, 100 or more cameras.

The term “real-time” means processing may be sufficiently fast that resulting information may be used for making decisions substantially at the time of operation. Non-limiting examples may be for applications on one or more of the following: a car, a truck, a train, an airplane, a helicopter, a drone, a satellite, a tractor, a ship, mobile farm or mining equipment, a fixed crane or observation point (e.g., security viewpoint) or a boat where real-time processing may be processing that may be performed within 100 minutes, 10 minutes, 1 minute, 1 second, 100 ms, 10 ms, 1 ms or other value appropriate to the situation.

The term “real-time frame rates” means the capacity of a processing system to process image data at real-time speeds. In certain embodiments, in processing image data the real-time frame rate may be at least 0.1, 1, 10, 30, 60, 100, or higher frames per second. In certain embodiments, in processing image data the real-time frame rate may be between 0.1 to 1, 0.1 to 10, 0.1 to 100, 1 to 100, 1 to 60, 1 to 30, 1 to 10, 10 to 100, 10 to 60, 30 to 100, 30 to 60, 60 to 100, or higher frames per second.

The term “camera pair” means a pair of cameras selected from a plurality of available cameras.

The term “image pair” means a pair of images captured, for example, from one or more cameras, potentially at different times within a relatively static time period, such that they represent the appearance of a scene from two different points of view that are separated by a non-trivial baseline. This baseline may be a consequence of their relative positions on a platform or vehicle on which they are mounted, the movement of the camera platform in, over or past the scene during the time elapsed between the image captures, or a combination of both. An image pair may also mean data that may comprise at least in part computational transformations of other data where there may be an advantage to store the transformed data in a manner mappable to two 2D grids evocative of an image-like structure.

The term “reference surface” means a conceptual surface, typically not a physical surface, with a known geometric position relative to one or more cameras at a particular time that may be used as a common reference for determining depths in a scene from multiple cameras as they move within, over or past the scene during a relatively static time period. The reference surface may be curved, may be planar or combinations thereof.

The term “small particle occlusions” means one or more transient objects that may be ignored, or substantially ignored, for the purposes of a particular application of the system. For example, in the case of driving a standard car along a road, raindrops may not need to be avoided and may not represent a safety threat. In this application therefore raindrops may be deemed small irrelevant particle occlusions. Further similar non limiting examples include one or more of the following: snow, hail, dust, individual leaves or other light objects floating in the air, insects, bullets, birds and drones.

The term “extrinsic camera parameters” mean parameters describing the camera's location and orientation in space with respect to a designated frame of reference or origin. The extrinsic camera parameters may be represented as a 3D translation vector [x, y, z] and a 3×3 rotation matrix.

The term “intrinsic camera parameters” mean parameters that describe how a particular camera maps 3D points observed in the real world into the camera image plane or image sensor; the intrinsic parameters thus characterizing the optical and geometric properties of the camera. For example, intrinsic camera parameters may include one or more of the following: the field of view, focal length, the image center, descriptors of radial lens distortion, and descriptors of other distortions. The intrinsic parameters may describe the process by which 3D points, 3D neighbourhoods, physical surfaces and other objects in the scene are imaged by the camera in capturing an image of the scene and thereby produce pixel data.

### Certain Exemplary Advantages

In addition to other advantages disclosed herein, one or more of the following advantages may be present in certain exemplary embodiments:

One advantage may be that an accurate 3D scene information stream may be calculated at real-time frame rates, or substantially real-time frame rates, to facilitate decisions by higher level systems. Examples include, but are not limited to, navigation decisions, trajectory selection, collision avoidance, road following, driving risk assessment, safe speed determination, driver assistance, driver alerts, safe distance following, personal space navigation, or combinations thereof.

Another advantage may be there is no need, or lesser need, for other sensors (for example, radar and/or LiDAR). This reduction in the need for other sensors substantially reduces the cost and/or complexity of implementing autonomous navigation in vehicles, robots and/or planes. In certain embodiments, however, other sensors (for example ultrasonics, radar and/or LIDAR) may be added to supplement the system.

Another advantage of certain embodiments may be there is not a need, or less of a need, for integration between disparate sensor systems. This may substantially reduce the cost and/or complexity of implementing autonomous navigation in vehicles, robots and/or planes. The present disclosure contemplates integration between disparate sensor systems, which may nevertheless be included in certain embodiments.

Another advantage of certain embodiments may be that it reduces the deleterious impact of small particle occlusions (non-limiting examples being rain, snow, dust, and insects) on the performance of the system, as the visible impact of such occlusions in 2D images made using sensor elements sensitive to many of the spectral ranges in and near the conventional visual spectrum may be not as severe as in LiDAR or other alternative sensing modalities.

Another advantage of certain embodiments may be that cameras may be placed so that their camera centres are not restricted to planar or colinear arrangements without impacting the efficiency of one or more of the systems and/or one or more of the methods disclosed herein. This lack of viewpoint restrictions may also facilitate efficient use of image data from a camera that moves through the scene because the movement of the camera may not be required to follow a planar and/or linear path, and may instead follow other suitable trajectories. This may distinguish systems in this disclosure from other systems and techniques in the art where computational efficiencies may be possible only when camera centres are constrained to be coplanar or colinear.

In addition, because there may be multiple cameras moving in the scene means that objects obscuring, or partially obscuring the view from some viewpoints, potentially for only brief periods of time, may not substantially impact the performance of the system.

Another advantage of certain embodiments may be that an accurate 3D scene information stream may be calculated at real-time frame rates, or substantially real-time frame rates, facilitating tracking objects in a scene to enable one or more of the following: security and surveillance of streets, parks, private or public spaces or buildings where real-time, 3D information may allow tracking people, identifying actions and activities, assist with detection of unusual behaviours, determine information about the flow of people or vehicles in a space, determine alerts such as collisions or slip-and-fall, monitoring the size of crowds, and monitoring the flow and/or behaviour of crowds.

Certain embodiments are directed to using passive optical systems to produce 3D scene information of scenes in real-time, or substantially real-time.

### System Diagram

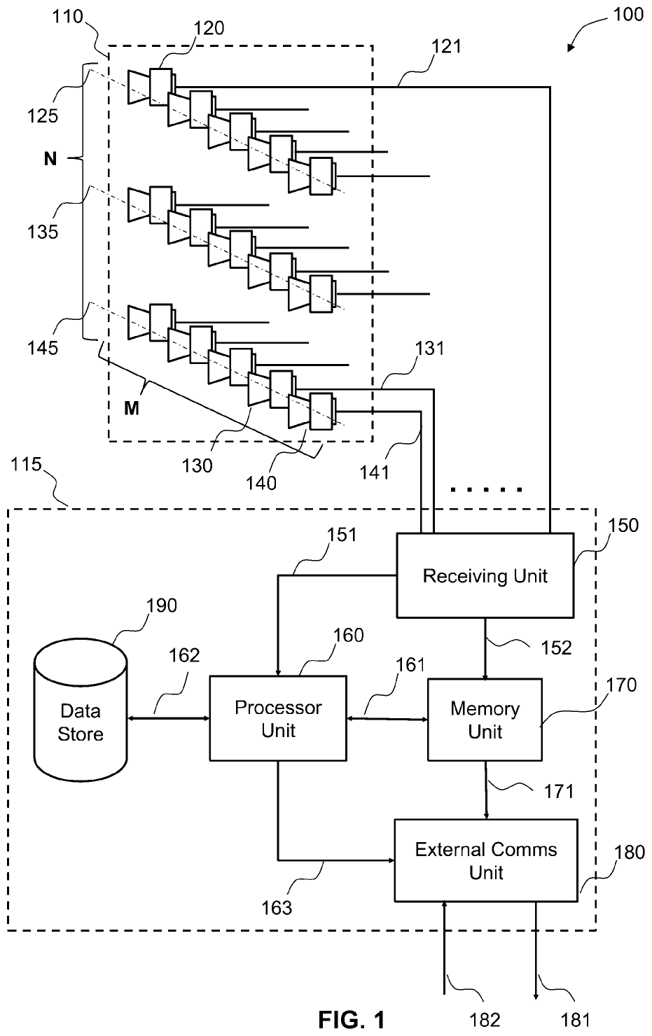

FIG. 1 shows an exemplary system (100). FIG. 1 includes an exemplary configuration of cameras on a camera platform 110 and an exemplary computer system (115). In certain embodiments, one or more computer systems perform one or more steps of one or more methods described or disclosed herein. In certain embodiments, one or more computer systems provide functionality described or shown in this disclosure. In certain embodiments, software configured to be executable running on one or more computer systems performs one or more steps of one or more methods disclosed herein and/or provides functionality disclosed herein. Reference to a computer system may encompass a computing device, and vice versa, where appropriate.

This disclosure contemplates a suitable number of computer systems. As example and not by way of limitation, computer system (115) may be an embedded computer system, a system-on-chip (SOC), a single-board computer system (SBC) (such as, for example, a computer-on-module (COM) or system-on-module (SOM)), a desktop computer system, a laptop or notebook computer system, a main-frame, a mesh of computer systems, a personal digital assistant (PDA), a server, a tablet computer system, an augmented/virtual reality device, or a combination of thereof. Where appropriate, computer system (115) may include one or more computer systems; be unitary or distributed; span multiple locations; span multiple machines; span multiple data centres; or reside in a cloud, which may include one or more cloud components in one or more networks. Where appropriate, one or more computer systems (115) may perform without substantial spatial or temporal limitation one or more steps of one or more methods described or illustrated herein. As an example, and not by way of limitation, one or more computer systems (115) may perform in real time or in batch mode one or more steps of one or more methods disclosed herein.

The computer system (115) may include a processor unit (160), memory unit (170), data storage (190), a receiving unit (150), and an external communication unit (180).

The processor unit (160) may include hardware for executing instructions, such as those making up a computer program. As an example, and not by way of limitation, to execute instructions, processor unit (160) may retrieve the instructions from an internal register, an internal cache, memory unit (170), or data storage (190); decode and execute them; and then write one or more results to an internal register, an internal cache (not shown), memory unit (170), or data storage (190). The processor unit (160) may include one or more internal caches for data, instructions, or addresses. This disclosure contemplates processor units (160) including a suitable number of suitable internal caches, where appropriate. The processor unit (160) may include one or more instruction caches, one or more data caches, and one or more translation lookaside buffers (TLBs). Instructions in the instruction caches may be copies of instructions in memory unit (170) or data storage (190), and the instruction caches may speed up retrieval of those instructions by processor unit (160).

The memory (170) may include main memory for storing instructions for processor to execute or data for processor to operate on. The computer system (115) may load instructions from data storage (190) or another source (such as, for example, another computer system) to memory unit (170). The processor unit (160) may then load the instructions from memory unit (170) to an internal register or internal cache. To execute the instructions, the processor unit (160) may retrieve the instructions from the internal register or internal cache and decode them. During or after execution of the instructions, the processor unit (160) may write one or more results (which may be intermediate or final results) to the internal register or internal cache. The processor unit (160) may then write one or more of those results to the memory unit (170). The processor unit (160) may execute only instructions in one or more internal registers or internal caches or in the memory unit (170) (as opposed to data storage (190) or elsewhere) and operates only on data in one or more internal registers or internal caches or in memory unit (170) (as opposed to data storage (190) or elsewhere). One or more memory buses may couple processor unit (160) to memory unit (170). The Bus (not shown) may include one or more memory buses. The memory unit (170) may include random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. Memory unit (170) may include one or more memories, where appropriate.

The data storage (190) may include mass storage for data or instructions. The data storage (190) may include a hard disk drive (HDD), flash memory, an optical disc, a magneto-optical disc, magnetic tape, or a Universal Serial Bus (USB) drive or a combination therein. Data storage (190) may include removable or non-removable (or fixed) media, where appropriate. Data storage (190) may be internal or external to computer system, where appropriate. Data storage may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination thereof.

In certain embodiments, I/O interface (not shown) may include hardware, software, or both, providing one or more interfaces for communication between computer system and one or more I/O devices. Computer system may include one or more of these I/O devices, where appropriate. One or more of these I/O devices may enable communication between a person and computer system. An I/O device may include a keyboard, keypad, microphone, monitor, mouse, printer, scanner, speaker, still camera, stylus, tablet, touch screen, trackball, video camera, another suitable I/O device or a combination thereof. An I/O device may include one or more sensors. This disclosure contemplates any suitable I/O devices and any suitable I/O interfaces for them. Where appropriate, I/O interface may include one or more device or software drivers enabling the processor unit (160) to drive one or more of these I/O devices. I/O interface may include one or more I/O interfaces, where appropriate.

FIG. 1 shows a system diagram 100 of certain exemplary embodiments. The system includes a camera platform 110 and a computer system 115. The computer system may be configured to execute certain exemplary embodiments.

In certain embodiments, the relative position and/or orientation of cameras on the camera platform 110 may be known. In certain embodiments, the cameras on the camera platform may have a trigger (not shown) that enables image frames to be captured at specific times, or at least have the time of the image capture be recorded at a precision at least as fine as the interval chosen for the application as fulfilling the definition of a relatively static time period. In certain embodiments, the camera platform may include related circuitry (not shown) to ensure capture of images from cameras on the camera platform at times controlled by external systems.

The computer system 115 includes a receiving unit 150 for communication with the cameras on the camera platform 110. The receiving unit may be connected via communication bus 151 with the processor unit 160, and a memory unit 170. The processor unit 160 may be a general-purpose CPU or GPU or may be customised hardware such as an FPGA or ASIC designed to perform the required processing. The memory unit 170 may include volatile and/or non-volatile memory. It may store instructions for the processing unit 160 as well as image data received from the receiving unit 160 via the communications bus 152. The processing unit 160 may also be connected to a data store 190 via communications bus 162. The processing unit 160 may be also connected to an external communications unit 180 via 163. The communications unit 180 may be used to output a stream of 3D information for the use of external systems (not shown). The communications unit 180 may also receive data from external sources including one or more of the following: image data from one or more cameras, position data, map data, and previously recorded data regarding the scene, and previously recorded 3D information and/or other data regarding the scene.

Cameras on the camera platform 110 may be connected to the computer system 115. Cameras may have a communication channel indicated by 121, 131, 141 to accept control and/or synchronisation signals and to output image data. Capture of images from one or more cameras on the camera platform 110 may be triggered by signals sent over the communication channel 121, 131, 141. In certain embodiments, cameras external to the camera platform may be connected to the computer system (for example, 115) and these cameras may contribute to the determination of 3D scene information.

### Exemplary Camera System

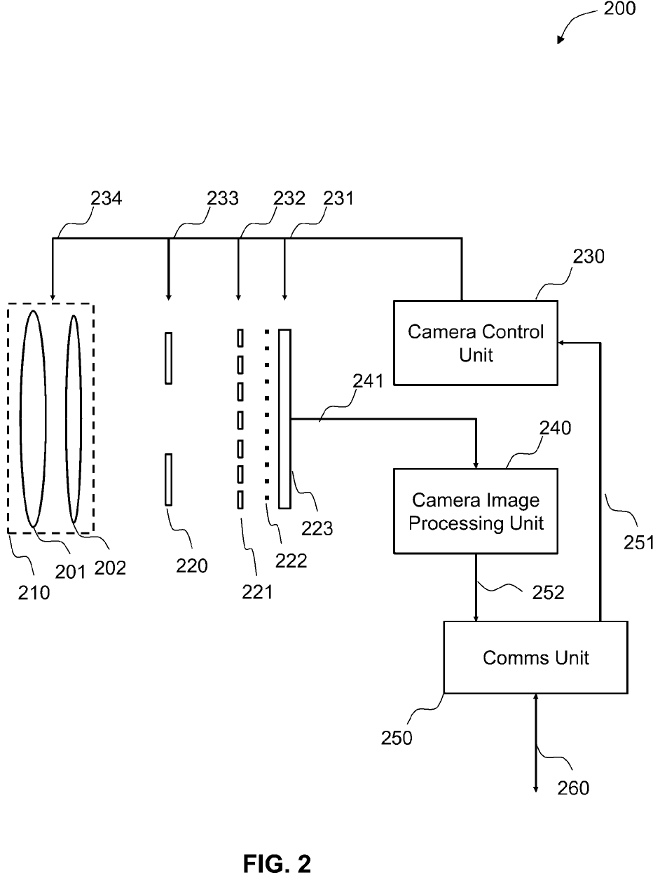

FIG. 2 describes the details of an exemplary camera system 200 which may be used for cameras on the platform 110. The camera system includes a lens module 210 consisting of optical elements 201, 202. There may be also an aperture 220, a shutter 221 and a sensor 223. In certain embodiments, the sensor 223 may be overlaid with a filter array, for example a Bayer filter 222, which enables the capture of colour and/or multi-spectral images. The sensor 223 may be sensitive to a portion of the electromagnetic spectrum, including, but not limited to, one or more of the following: the visual, the infra-red and the ultraviolet spectrum.

The sensor 223 may be connected to a camera image processing unit 240 which may perform image processing of raw image data captured by the sensor 223. In certain embodiments, the image processing steps may include one or more of the following: de-Bayering, compensating for lens distortion, or colour corrections. In certain embodiments, processing images to compensate for lens distortion unwarps the images so that they conform, or substantially conform, to the output of a pin-hole camera model (such model being well known in the art). Many camera lens systems generate images with certain warping, for example, a fish-eye lens warps a scene into a wide panoramic representation of the world but one where lines of perspective are warped. By compensating for lens distortion, straight lines in the scene may appear straight in the processed images.

Processed images may be passed via communication bus 252 to the communications unit 250. Processed image data may be sent via 260 to the computer system 115. The communications unit 250 may also receive control and/or triggering signals from the computer system 115. Control and/or triggering signals may be passed onto camera control unit 230. The camera control unit 230 actions camera control signals via control lines 234, 233, 232, 231 enabling adjustment of one or more of the following components of the lens system 210: the aperture 220, the shutter 221 and the sensor 223. Such controls may be used to adjust one or more of the following: imaging parameters (such as gain), exposure times, white and/or black level offsets and filter settings. The camera control unit 230 may also coordinate the activation of one or more of the following: the aperture 220, the shutter 221 and the sensor 223 to capture images. The camera control unit 230 may receive a synchronization signal via the Comms Unit 250 which ensures that cameras on the platform 110 are triggered to capture images as required.

### Exemplary Illustrative Scene

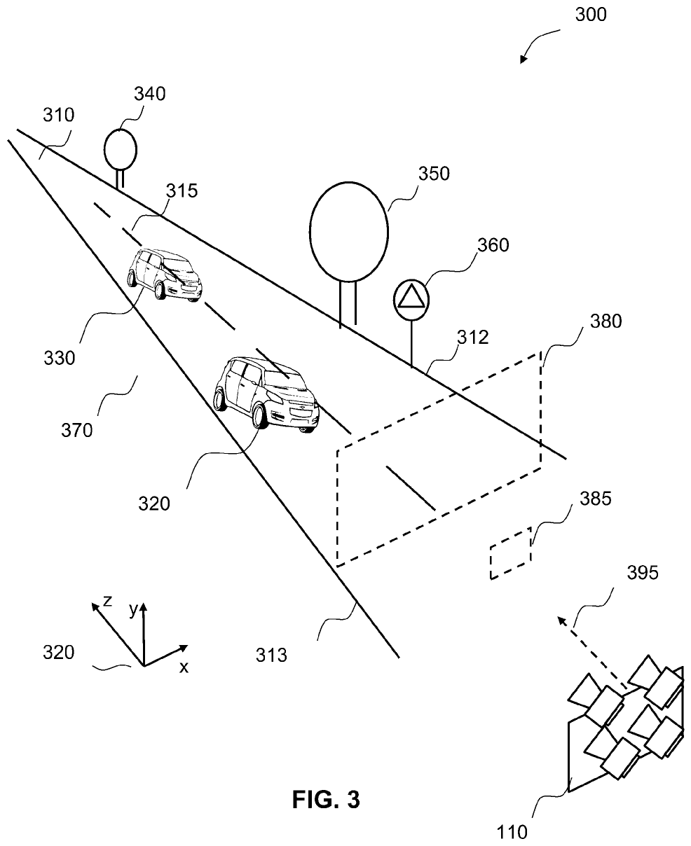

FIG. 3 shows a figurative scene 300. The road 310 may be illustrated with lines 312, 313 marking the edge of the road marking 315 for the centre line of the road 310. In this scene there are two cars 320, 330 on the road. Also shown are trees 340, 350 and a sign 360, positioned to the side of the road. A camera platform 110 is shown oriented to observe the scene. The camera platform 110 may be located on a vehicle (not shown). The camera platform 110 may move through the scene as indicated by arrow 395. A dashed rectangle marks the location and orientation of a reference surface 380, positioned in the view of the camera platform 110. The reference surface 380 (shown here as a plane) forms a common reference for generation of 3D information using images from the cameras of the camera platform 110.

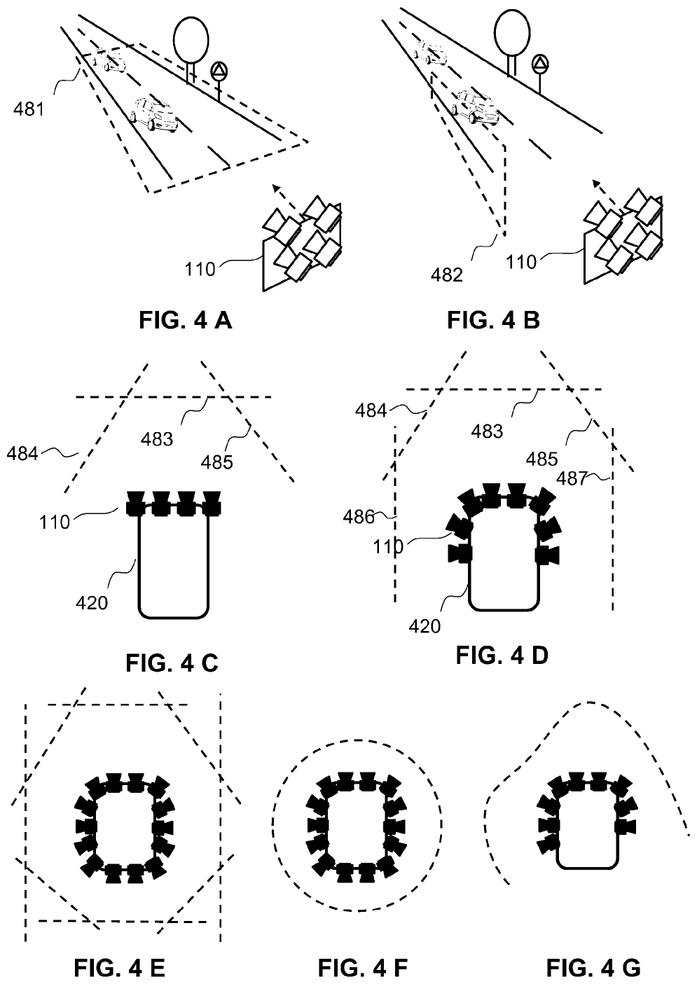

FIG. 4 A shows an alternative arrangement where the reference surface 481 lies in a horizontal orientation, approximately parallel to the ground and approximately on the same level as the ground. FIG. 4 B shows an alternative arrangement where the reference surface 482 lies in a vertical orientation but to the side. Other orientations of the reference surface are also possible, for example parallel to the ground and above the road surface or perpendicular to the ground and posed diagonally to one forward quarter of the vehicle. Depending on the application of a particular embodiment, the orientation of the reference surface may affect the computational costs and/or accuracy of the depth estimation process.

There may also be advantages, even with a single camera, to construct several reference surfaces (or sets of reference surfaces). Reference surfaces may be selected that reflect the a-priori known likelihood of where physical surfaces may appear during operation of the camera array. For example, in the case of an autonomous car, the ground may be typically horizontal and buildings (in built up areas) typically align to vertical planes on the sides of the road. In certain embodiments, multiple reference surfaces may be used with a camera platform. FIG. 4 C shows a camera platform 110 set in a forward position on a vehicle 420 has set about it reference surface 483, 484 and 485, one or more of which may be used as a basis for determining depths according to this disclosure. FIG. 4 D shows a camera platform 110 configured in an arc and multiple reference surface 483, 484, 485, 486 and 487 set about the vehicle 420 to the front and sides and on the left and right forward quarters. FIG. 4 E shows a further possible arrangement with a camera platform providing a 360 degree orientation and, in this example eight reference surfaces also set about the vehicle giving a 360 degree coverage. FIG. 4 F and FIG. 4 G shows further possible arrangements with a camera platform providing a 360-degree orientation and an irregular curved reference surface having a limited coverage about the vehicle.

In certain embodiments, the one or more cameras may be associated with a mobile platform or vehicle. In certain embodiments, at least one of the one or more cameras may be associated with a mobile platform or vehicle, and at least one other of the one or more cameras may be associated with a stationary structure in the scene.

In certain embodiments, at least one camera of the one or more cameras may be associated with the mobile platform or vehicle that is configured to be mobile and at least one other camera of the one or more cameras may be associated with a stationary platform and is configured to be stationary.

In certain embodiments, at least one camera of the one or more cameras may be configured to be mobile and at least one other camera of the one or more cameras may be configured to be stationary.

In certain embodiments, at least one camera of a camera array may be mobile and at least other camera of the camera array may be stationary. For example, the mobile camera may be associated with a vehicle that is mobile (and will move with the vehicle) and the at least one other camera is stationary (or substantially stationary) and does not move with the vehicle. In certain embodiments, the camera array may be made up of a series of stationary camaras affixed to a series of lampposts telephone poles, and/or buildings and these stationary cameras (or substantially stationary) cooperate with cameras of the camera array that are mobile.

In certain embodiments, at least two cameras may be moving independent from each other in the scene, for example, cameras mounted on separate vehicles that move independent from each other through the scene but via suitable communications infrastructure a substantial portion of the data captured from the at least two cameras may be sent to at least one image processing system.

In certain embodiments, at least two cameras are moving independent of each other in the scene and at least one camera is stationary (or substantially stationary), for example cameras mounted on separate vehicles that move independent of each other through the scene, with at least a third affixed to a building nearby, and via suitable communications infrastructure at least a portion of the data from the at least two cameras and at least one stationary camera may be sent to at least one image processing system.

### Epipolar Planes and Lines

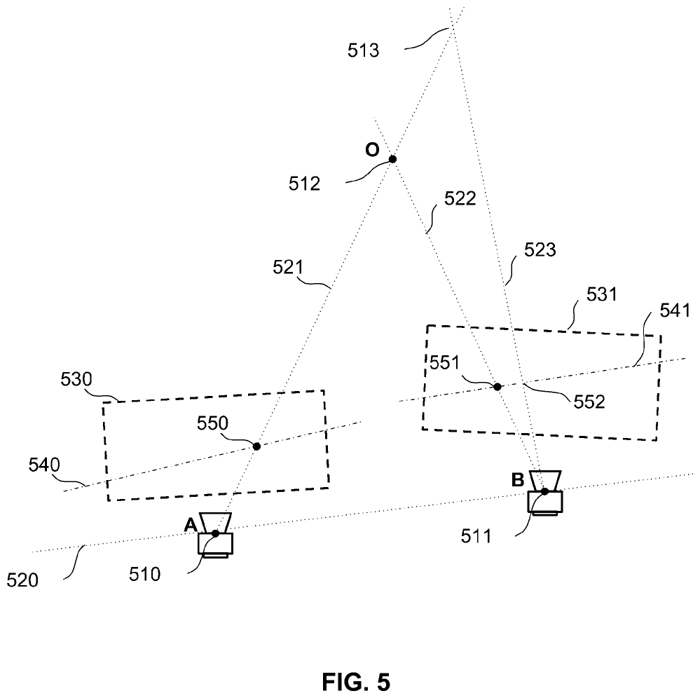

FIG. 5 may be used to describe an exemplary relationship between a scene, a pair of images, epipolar planes and associated epipolar lines. In this exemplary, an epipolar plane may be the plane defined by three 3D points: camera centre (or camera optical centre) A 510, camera centre (or camera optical centre) B 511, and a 3D point of interest in the scene O 512. The epipolar lines are the pair of lines defined by the intersections of the respective image planes of each image in the pair with the epipolar plane associated with a 3D point of interest in the scene (in this case O 512). Note that the image planes are typically substantially perpendicular to the epipolar planes, and so should be imagined in FIG. 5 to be cutting through the diagram page (partially above and partially below the page). Referring to FIG. 5, an arrangement of camera A 510 and camera B 511 are shown observing a Scene with a 3D point of interest O 512. Also shown is a representation of the image data 530 showing the view of camera A 510, and representation of the image data 531 showing the view of camera B 511. As illustrated, camera A 510 and camera B 511 may be posed with different orientations (e.g., pan, tilt and/or rotation) and/or different intrinsic parameters (e.g., focus, zoom) so consequently their image data 530, 531 may appear rotated and/or stretched with respect to one another other and with respect to the epipolar plane. As shown by dashed line 540 the epipolar plane intersects the image plane 530 of camera A 510 and similarly 541 marks where the epipolar plane intersects the image plane 540 of camera B 511. Considering the appearance in the scene of a physical surface located at 3D point O 512, the physical surface may be observed in image 530 at 550 on the epipolar line 540 and similarly may be observed in image 531 at 551 on the epipolar line 541. However, an observation in image 531 at 552 (instead of 551), also on the epipolar line 541 would indicate the location of the physical surface at 513 (instead of 512). In this example, camera A 510 and camera B 511 may be different cameras or camera B 511 may be the same camera as camera A 510 moved to a new location (within the relatively static time period).

### Epipolar Rectification

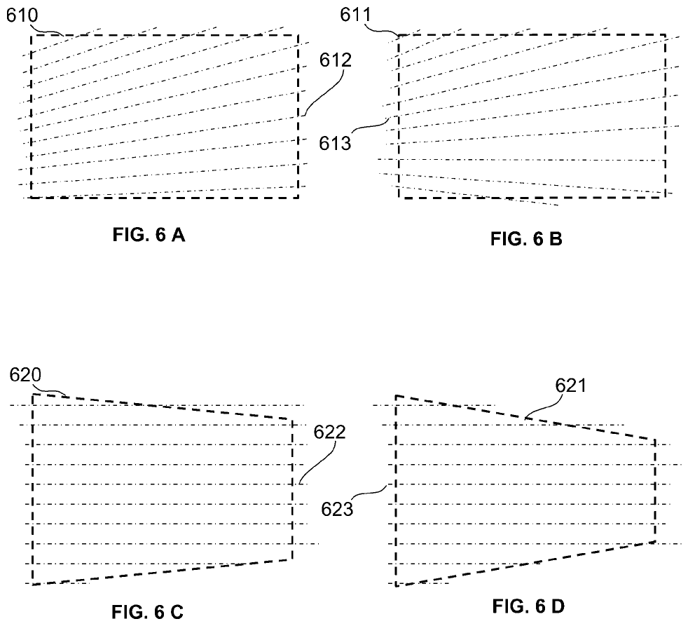

Referring to FIG. 6 A an image 610 on the left is the image data captured by camera A 510 in the image pair and the image 611 (in FIG. 6 B) on the right is the image data captured by a camera B 511 in the image pair (where camera A and camera B may be the same physical camera that has moved in the scene due to the movement of the camera platform 110). Epipolar lines for the left image, for example, 612 and for the right image, for example, 613 may depend on the relative positions of the two viewpoints from which the camera or cameras were positioned in the scene at the precise time(s) of capture. The epipolar lines for images 610 and 611 may be determined from the intrinsic camera parameters and extrinsic camera parameters determined during a process of camera calibration and known movement (if any) of the cameras. Camera calibration techniques, both for multiple cameras at fixed positions on a platform as well as for cameras that move over time, are known in the art. An image warp may then be used to transform image data so that epipolar lines become horizontal, and the image data along horizontal scanlines may be, therefore, in a more useful arrangement for subsequent processing (i.e., horizontal shifts and offsets may be how pixel data is processed in subsequent processing stages). FIG. 6 C shows the result of epipolar warping on the image of FIG. 6 A. And, FIG. 6 D shows the result of epipolar warping on the image of FIG. 6 B. For example, in FIG. 6 C image 620 shown, with epipolar lines including 622 now horizontal and image 621 (FIG. 6 D) also with epipolar lines such as 623. Further, warped images 620 and 621 may be generated so that epipolar lines 622 and 623, where from the same, or substantially the same, epipolar plane, may be stored in same, or substantially same, row position in their respective images.

### Construction for Consistent Depth Shift Images

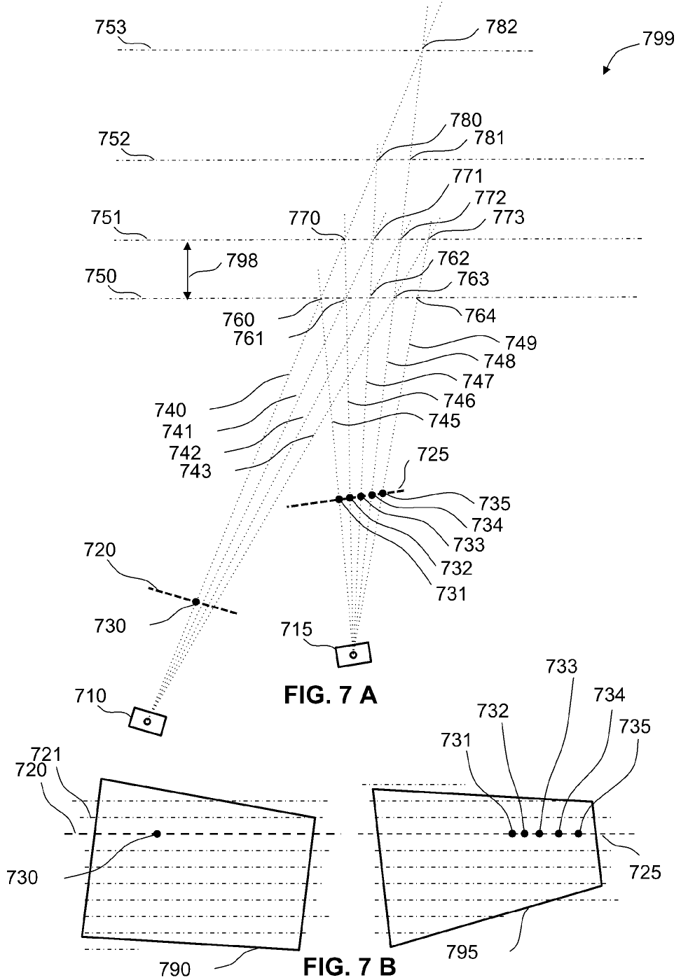

An exemplary geometric construction for generation of pairs of consistent depth shift images is also disclosed herein. The construction within a single epipolar plane is shown at an exemplary position in FIG. 7 A (the epipolar plane may be the plane of the diagram itself 799) and projected onto a single scanline 720 in the consistent depth shift image 790, also where context permits referred to as a rectified image (as shown in FIG. 7 B). The single scanline 720 appears also in FIG. 7 A as the dotted intersection between the image plane of the camera and the epipolar plane 799. This construction process may be repeated on other epipolar planes oriented at other angles about the line between the camera centres 710, 715 (in this way the line joining 710 and 715 may be the only line contained in all, or substantially all, epipolar planes). Repeating the process for these other epipolar planes which consequently intersect the image plane 790 at different heights and thus set out along different horizontal scanlines, creates a 2-dimensional image whose horizontal scanlines may be substantially derived from the image data extracted from the original image along substantially epipolar lines (shown in FIG. 7 B at, for example, 720, 721 and by extension the other dotted horizontal lines shown).

FIG. 7A is an arrangement of camera A 710 and camera B 715 that are shown observing a scene (where camera A and camera B may be the same physical camera that has moved in the scene due to the movement of the camera platform 110 to which none, or one or more of the cameras may be attached). A thick dashed line 720 (FIG. 7 A left side) represents an epipolar line in the image of camera 710 and another thick dashed line 725 (FIG. 7 A right side) represents an epipolar line in the image of camera 715. A dot-dash line represents the reference surface 750 (FIG. 7A), being the intersection of the reference surface and an epipolar plane (799); further surfaces at constructed offsets 751, 752 and 753 are also shown and referred to as derived reference surfaces. On the epipolar line 720 of camera 710 a physical surface may be observed at 730. The physical surface may be deduced to lie on the line 740 projecting from camera 710 through 730 and into the scene. The physical surface may, for example, be observed by camera 715 on epipolar line 725 at 731. Then by projecting line 745 and using triangulation the physical surface may be deduced to be at 3D point 760 where lines 740 and 745 intersect if sufficient agreement may be found between the pixel 730 (captured by camera 710) and pixel 731 (captured by camera 715). Derived reference surface 751 may be positioned with a known offset to the reference surface 750. The line 740 intersects with derived reference surface 751 at 3D point 770, and a line 746 drawn through 770 and camera 715 intersects the epipolar line 725 of camera 715 at 3D point 731. As an alternative example, if close pixel agreement with 730 was observed in camera 715 not at pixel 731 but instead at pixel 732, this indicates that the physical surface may be more likely at the 3D point 770 on the derived reference surface 751. Continuing with the construction, line 746 intersects the Reference Plane 750 at 761 and this 3D point may be used as the basis for a new line 741 produced from camera 710, through 761. Repeating the process, line 741 intersects derived reference surface 751 at 3D point 771 and new line 747 and its projection (733) onto the epipolar line 725 of camera 715 are thus defined. Lines 740 and 747 intersect on a derived reference surface 752; a physical surface in the scene observed in camera 710 at 730 and in camera 715 at 733 may be deduced to lie at 3D point 780 on derived reference surface 752 by checking for sufficient agreement between the pixel data captured by camera 710 at location 730 and by camera 715 at location 733. The construction may be continued further generating points on the epipolar line 725 for camera 715 that correspond to suppositions of physical surfaces potentially in the scene on surface 753 and beyond. The pixels at points 731, 732, 733, 734, 735 and beyond may be envisaged on the epipolar line 725. A change of close pixel data agreement in camera 715 to the right, say, for example, from 734 to 735 may indicate an increase in the deduced physical surface's depth to be aligned on a derived surface further away from the cameras (up the page); and to the left, say from 734 to 733 may indicate a decrease in the deduced physical surface's depth to a derived surface nearer to the cameras.

Referring to FIG. 7B image 790 represents an image from camera 710 warped by epipolar rectification as viewed along the horizontal epipolar lines (e.g., 720, 721) indicated with dot-dash lines in the illustration. Similarly, image 795 represents an image from camera 715, also after epipolar rectification and with epipolar line 725 shown with a dashed line. The observed point 730 is again shown in the image 790 lying on the epipolar line 720. And similarly observed points 731, 732, 733, 734, 735 are again shown in the image 795 lying on the epipolar line 725.

Typically, in stereo rectification the spacing of points along an epipolar line is often selected to be uniform. However, in certain disclosed embodiments, the spacing of points 731, 732, 733, 734, 735, and so forth on the epipolar line 725 may not be uniform and may be determined by the relative 3D positions of the camera 710 and 715, the reference surface 750 and a single depth offset to one of the derived reference surfaces (shown in this example as the gap between 750 and 751 indicated by 798). There may be computational efficiency to be gained by arranging pixel locations along one or more epipolar lines to be spaced so as to represent confluences of depths on the spaced out reference surface and/or set of derived reference surfaces (750, 751, 752, 753, and beyond). In the case where the reference surface is planar, the spacing that achieves this may be shown to follow a geometric progression along the epipolar line 725 (FIG. 7 B) and may be calculated in detail by the geometric construction just described or by other methods based on suitable mathematical and/or geometric principles (e.g., analytic geometry).

As shown and described in the construction, the chosen shape of a reference surface (e.g., 750) and a separation distance to a first derived reference surface of a chosen shape (e.g., 751 and 750 are simple planes and 751 may be separated from 750 by the chosen spacing 798) defines the locations of the intersection 3D points such as 760, 770, 780, 782 and 761, 771, 781, etc, as well as the locations and shapes of other derived reference surfaces 751, 752, 753 etc. These intersection 3D points may be considered members of 3D neighbourhoods. Other images (not shown in FIG. 7 A) may be taken from positions above, below in front or behind (this may be due to camera movement or the availability of other cameras) the illustrated plane (i.e., not on the illustrated epipolar plane 799), and other image pairs may be defined by selecting images from them. These other image pairs may have their own epipolar planes, epipolar lines and intersection points as constructed similarly as described using the same, or substantially the same, reference surface and derived reference surfaces. The intersection points for these other image pairs may not coincide with the intersection points for the camera pair 710, 715 (e.g., intersection points 760, 770, 780, 782 and 761, 771, 781, etc.). Nevertheless, intersection points generated on other epipolar planes with other image pairs may be found that are near to the intersection points 760, 770, 780, 782 and 761, 771, 781, etc such that of 3D neighbourhoods of suitably limited 3D extents may be formed around clusters of intersection points, a substantial number of which may contain contributions from a substantial number of image pairs.

Information sampled from the 3D points in these 3D neighbourhoods, from the points of view of various cameras, form the basis of assessing the likelihood of whether a there is a physical surface at the 3D locations characterized by the 3D neighbourhoods thus formed.

Construction for Consistent Depth Shift with Curved Reference Surface

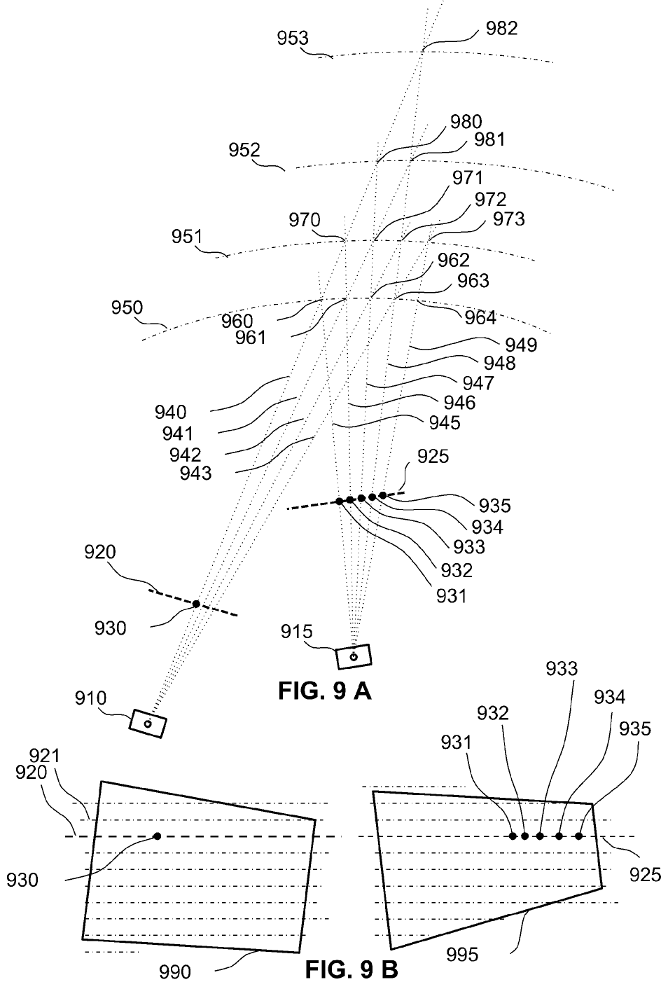

In certain embodiments, it may be advantageous to use a reference surface that may be a curved 2D form extending through the 3D scene. For example, a spherical form, an ovoid form or some other suitable 2D surface embedded in the scene. FIG. 9 A illustrates the construction of constant depth shift for a reference surface 950 shown as a curved, dot-dashed line. The construction within a single epipolar plane is shown at an exemplary position in FIG. 9 A (the epipolar plane may be the 2D plane of the diagram similarly to FIG. 7 A) and projected onto a single scanline 920 in in the rectified image 990 (as shown in FIG. 9 B). Again, similarly to FIG. 7 A, the scanline 920 may be the intersection of the epipolar plane under consideration and camera 910's image plane. This construction process may be repeated on other epipolar planes at other angles about the line between the camera centres 910, 915. Repeating the process for other epipolar planes creates a 2-dimensional image whose horizontal scanlines may be substantially derived from the image data extracted from the original image substantially along epipolar lines (shown in FIG. 9 B at for example 920, 921). The constant depth shift construction for a curved reference surface may be, as shown in FIG. 9 A, analogous to the construction for a reference surface that may be a flat plane as was disclosed in relation to FIG. 7 A. A point 930 (FIG. 9 B lower left side) on epipolar line 920 projects to the reference surface at 960 and extended from the reference surface intersects a curved derived reference surface 951 at 3D point 970. From 3D point 970, line 946 traces back toward the camera centre 915 intersecting the Reference Surface 950 at a 3D point 961. Continuing this method, the progression of a series of 3D points 960, 961, 962, 963, 964 may be determined, which may be projected back to the epipolar line 925 forming points 931, 932, 933, 934 and 935. In general, the spacing of points 931, 932, 933, 934 and 935 (FIG. 9 B lower right side), and so forth on the epipolar line 925 may not be uniform and may be determined by the relative 3D positions of cameras 910 and 915, the position and shape of reference surface 950 and the position and shape of a single derived reference surface (remaining depth offsets at positions on epipolar planes between potentially numerous derived reference surfaces are defined by construction following these initial choices). In certain embodiments, computational efficiency may be gained by arranging pixel locations along one or more epipolar lines to be spaced so as to represent confluences of depths on the spaced out reference surface and/or set of derived reference surfaces (950, 951, 952, 953, and beyond).

### Consistent Depth Shift Warp

The consistent depth shift warp performs image rectification, to images in an image pair, according to the construction for consistent depth shift images and additionally may perform compensation along the scanlines so that resulting rectified images have sufficiently high resolution as compared to the original images. The resulting pair of images may be referred to as a pair of consistent depth shift images, or where context permits, rectified images.

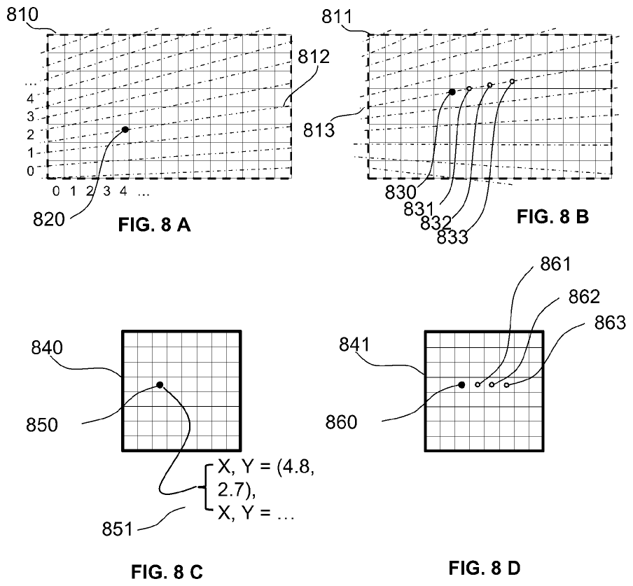

Referring to FIG. 8, an image pair of source images 810 (FIG. 8 A) and 811 (FIG. 8 B) are shown with an even grid indicating pixel locations in the original unrectified source images. For reference epipolar lines are shown with dot-dash lines including for example lines 812 and 813. An observed point 820 is shown in image 810 and another 830 is shown in image 811. Additional points marked with circles 831, 832, 833 indicate depth shifts along the epipolar line as may be determined by the described geometric construction for generation of consistent depth shift images. In the lower half of FIG. 8, consistent depth shift warps 840 (FIG. 8 C) and 841 (FIG. 8 D) are constructed. Again, a regular grid indicates a division of the space into elements. At one or more of such elements, the location of the source pixel in the source image for the corresponding camera of the camera pair may be stored. In certain embodiments, the location of the source pixel may be stored as integer values for the row and columns of the image data in the source image. In certain embodiments, the location of the source pixel may be stored as fixed point, floating point or other type that enables description of the location to a fraction of a pixel.

By way of example, in consistent depth shift warp 840 there is an element at 850 which contains as shown at 851 X and Y coordinates describing the location of point 820 in source image 810. The mapping from 850 to 820 may be calculated by the consideration of epipolar warping and the geometric construction for generation of consistent depth shift images disclosed herein. As a further example, the consistent depth shift warp 841 and element 860 containing X and Y coordinates describing the location of point 830 in source image 811. In this case, the coordinates may be stored as real values having a fractional part to indicate a location for the source at a sub-pixel level of accuracy. In certain embodiments, a list of one or more X, Y coordinates and associated pre-calculated weights may be stored in the consistent depth shift warp.

### Applying a Warp to an Image

Given a target image and a warp 840 the process of warping a source image, e.g., 810, to a target image is to consider at least a portion of the pixels in the target image in turn. For a particular pixel in the target image, refer to the equivalent location in the warp 840 to find one or more source pixel locations in the source image, and this process may be repeated for at least a substantial portion of the target and source pixels. From the source image, the pixel data at the source pixel location may be copied into the target (rectified) image. In certain embodiments, the source pixel location may be addressed to a subpixel level and the target pixel may be written with pixel data derived from pixels in the source image in the neighbourhood of this point. In certain embodiments, a kernel may be used to sample the neighbouring pixels. In certain embodiments, a simple linear or bilinear interpolation may be used to calculate pixel data representing the source image at a subpixel location. In certain embodiments, interpolation weights or kernel weights may be varied according to the location in the source image or the location in the target image to ensure the accurate (i.e., interpolated sub-pixel) assignment of pixel colour and/or other pixel-level data such as optical flow data and/or other data in the resulting warped image.

Other relationships between the target pixel and source pixel data in a neighbourhood of the source image location are also contemplated.

### Exemplary Process

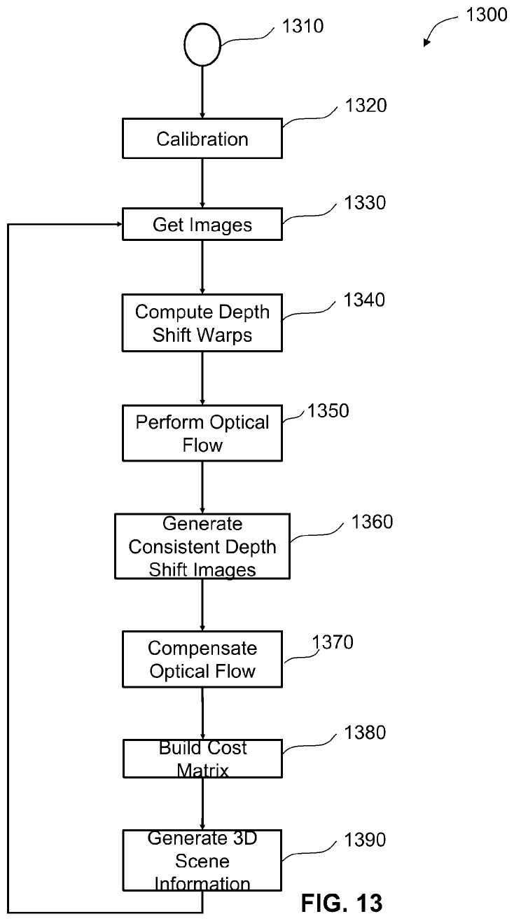

FIG. 13 shows a top-level flow chart 1300, according to certain embodiments. Starting from 1310 the exemplary system and/or method may proceed to perform the step Calibration 1320. Calibration 1320 involves calibration of the cameras on the camera platform 110 so that later steps may operate with images that are calibrated and registered to normalize their viewpoint. As part of this step the intrinsic camera parameters and/or extrinsic camera parameters of cameras may be determined and may be stored for use in later processing steps. Camera calibration is a known procedure and there are number of methods that may be applied. Following Calibration 1320 flow proceeds to the step Get Images 1330.

In the step Get Images 1330 the computer system 115 operates the cameras to capture one or more images, potentially at various times over a period of time. The cameras may provide de-Bayered images to the computer system 115. Following Get Images 1330, flow proceeds to step Compute Consistent Depth Shift Warps 1340.

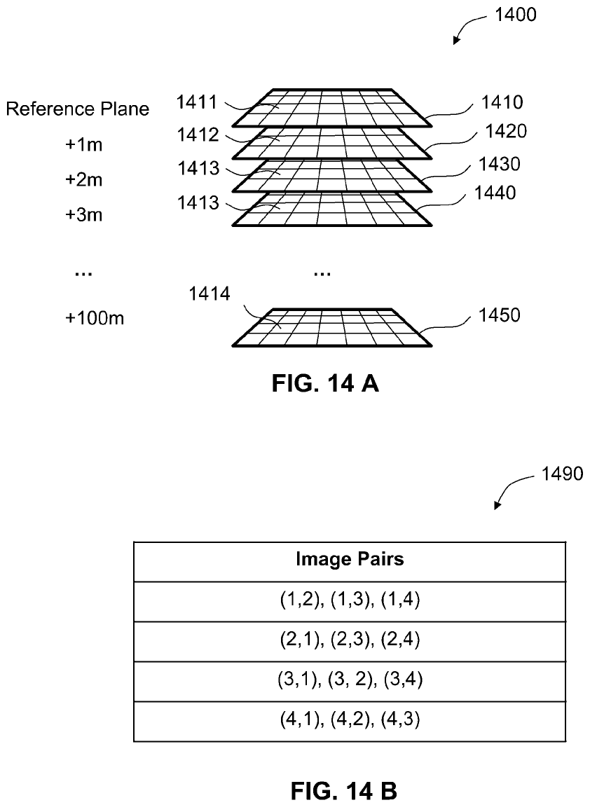

In step Compute Consistent Depth Shift Warps 1340, image pairs are selected from the images taken by the cameras during a relatively static time period. In certain embodiments, one or more combinations of image pairs are stored in a data structure such as shown in FIG. 14 B as 1490 from which image pairs may be accessed as required. Pairs of images may be chosen based on one or more of the following: their relative position, orientation, baseline separating the viewpoints from which they were taken, the focal length, resolution, spectral response, and other attributes of the cameras that took them. A Consistent Depth Shift Warp 1340 may be determined for at least one image pair in the one or more of the selected image pairs. The Consistent Depth Shift Warp 1340 may be derived from the intrinsic camera parameters and extrinsic camera parameters of the one or more cameras from which the images in the image pair were taken, for example, according to the approach described in relation to FIG. 6, FIG. 7, and/or FIG. 9. The warp may take the form as described in relation to FIG. 8.

In certain embodiments, calibration may be updated or generated regularly and step 1340 may import some, substantially all, or all of this new calibration data when generating Consistent Depth Shift Warps 1340 during operation. Following Compute Depth Shift Warps 1340 flow proceeds to step Perform Optical Flow 1350.

In the step Perform Optical Flow 1350, one or more current images and one or more previous images (i.e., images captured from the same camera at one or more earlier times) are processed to generate an optical flow field, i.e., a set of vectors representing the apparent local vertical and/or horizontal picture movement across the image of the image plane at one or more pixel locations. In certain embodiments, the optical flow field together with uncertainty bounds may be calculated for a substantial portion of the pixels. These bounds may enable subsequent processing to make suitable adjustments for image regions where the local image data does not allow for sufficiently precise calculation of the apparent movement in the image (this may be for example in image regions that appear as uniform colour with little or no texture information). The resulting image data may now include both spectral data (according to the image sensor sensitivities to portions of the electromagnetic spectrum) and optical flow data at a portion of the total number of pixel locations. For example, image data may comprise components for conventional colour values (i.e., RGB) and channels for optical flow components Dx, Dy representing apparent local 2D movement of the 2D image appearance at at least a portion of pixel locations. In certain embodiments, optical flow data may be represented in a different form, for example, by the angle and magnitude of the local image motion. Algorithms for performing optical flow are known in the art, for example the Horn-Schunck method and/or the Lucas & Kanade method. In certain embodiments, the optical flow may be performed as part of on-camera processing in the Camera Image Processing Unit 240 (FIG. 2). In certain embodiments, optical flow may be performed in the computer system 115. Following Perform Optical Flow 1350 flow proceeds to Generate Consistent Depth Shift Images 1360.

In the step Generate Consistent Depth Shift Images 1360, the computer system 115 applies the Consistent Depth Shift Warps 1340 to rectify image pairs that have been captured from cameras. Image pairs may correspond to cameras for which consistent depth shift warps have previously been computed in step 1340 if movement of the cameras is a pre-defined distance along a commonly used direction. In that case the geometrical calculations of the consistent depth shift warps may be pre-computed and reused multiple times. The selected image pair may be chosen by stepping through a data structure of image pairs such as shown in FIG. 14 B as 1490. Image pairs may be chosen based on one or more of the following: the relative position, orientation, baseline between viewpoints of the camera or cameras that captured the image pair, the focal length, resolution, spectral response, and other attributes of the camera or cameras. In certain embodiments, the selection of the image pair may be responsive to knowledge of the scene such as prior assumptions or externally supplied information of near or distant physical surfaces or objects. For at least one selected image pair, the two images of the pair are warped by applying the corresponding consistent depth shift warp which is described elsewhere in this disclosure. The resulting pair of consistent depth shift images may be stored in association with the camera or cameras that took the images, together with the movement, if any, of the camera or cameras during the relatively static time period, for use in following steps. Following Generate Consistent Depth Shift Images 1350 flow proceeds to step Compensate Optical Flow 1370.

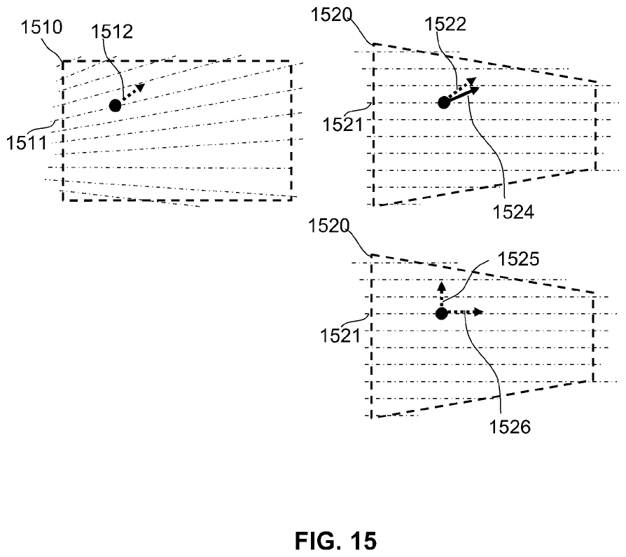

In the step Compensate Optical Flow 1370, the optical flow data may be adjusted to compensate for the warping of the images. FIG. 15, on the left illustrates an original image 1510 with epipolar lines, for example 1511; and for an example pixel location its optical flow data is shown as a vector 1512. Again, referring to FIG. 15, on the right is illustrated an image 1520 warped as by step Generate Consistent Depth Shift Images 1360 with epipolar lines, for example 1521, now running horizontally; and for an example pixel location its original optical flow vector 1522. Because of the relative change in the orientation of the epipolar lines, and the scaling of the shifts along epipolar lines, the optical flow vector must be suitably compensated before it may be included in the warped image; a compensated optical flow vector is shown at 1524. The compensation required for at least a substantial portion of the pixel locations may be calculated from geometric principles and may vary at different locations in the rectified image.

In certain embodiments, optical flow data may be decomposed into the component along the epipolar line 1526 and the component perpendicular to the epipolar line 1525 (FIG. 15, lower right).

In certain embodiments, the compensation of the optical flow data may be pre-calculated, for example, it may be determined as part of the step Compute Depth Shift Warps 1330. Following Compensate Optical Flow 1370, flow proceeds to step Build Cost Matrix 1380.

In the step Build Cost Matrix 1380 a three-dimensional cost matrix may be constructed using the pairs of image data produced in the previous steps. FIG. 14 shows a cost matrix 1400 including layers 1410, 1420, 1430, 1440 and 1450. Layers of the cost matrix may consist of a 2-dimensional grid of elements forming columns. For example, the elements 1411, 1412, 1413 and 1414 form a column though the layers of the cost matrix 1400. In certain embodiments, a substantial portion of layers may be associated with a reference surface and a set of derived reference surfaces respectively; for example, layers 1410, 1420, 1430 and 1440 may be associated with surfaces shown in FIG. 7 A at 750, 751, 752 and 753 respectively.

Sets of intersection points constructed from different image pairs (as per FIG. 7A) may fall at different locations in the scene, and their projections onto an image plane may fall at different 2D positions in the associated image. 3D neighbourhoods may be constructed around clusters of intersection 3D points, a substantial number of which may contain contributions from a substantial number of image pairs. At least a substantial portion of elements of the cost matrix may be associated with at least one of these 3D neighbourhoods. For example, cost matrix element 1411 may represent the 3D neighbourhood that contains intersection point 760 and cost matrix element 1412 may represent the 3D neighbourhood that contains intersection point 770.

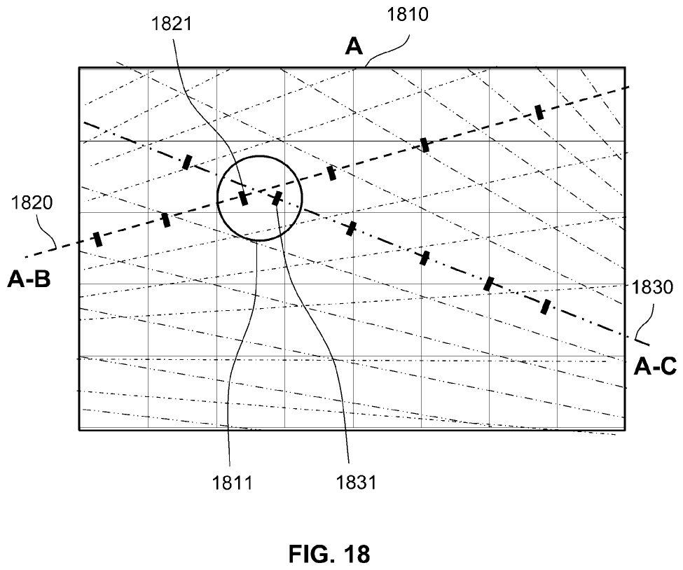

Referring to FIG. 18 image data for a camera “A” is shown as a rectangle 1810. A set of epipolar lines of an image pair, comprising images from cameras A and B (where camera A and camera B may be the same physical camera that has moved in the scene within the relatively static time period) are shown as dot-dash lines running diagonally up and to the right, including line 1820. For example, if camera B is considered that illustrated in FIG. 7 as 795, epipolar line 1820 might, for example, be line 725. For illustration along epipolar line 1820, heavy dash marks including 1821 indicate points on the epipolar line (for example points 731, 732, 733, 734 in FIG. 7) projected from intersection points (such as 760, 761, 762, 763 in FIG. 7). These points have corresponding pixel data from the associated rectified images (which in this case is derived from cameras A and B). Epipolar lines of another camera pair comprising cameras A and C are also shown on FIG. 18 as dot-dot-dash lines running diagonally down and to the right (including 1830). Again, for illustration, a set of heavy dash marks (including 1831) represent intersection points on the epipolar line 1830 constructed similarly to the process illustrated in FIG. 7. Again, these points have corresponding pixel data from their associated rectified images (which in this case is derived from cameras A and C). For simplicity heavy dash marks representing intersection points on other epiploar lines are not shown on FIG. 18.

For example, on epipolar lines 1820 and 1830, marks 1821, 1831 may represent intersection 3D points substantially on the reference plane (e.g., 750, FIG. 7 A) and, as exemplified by 1821 and 1831, intersection points from different image pairs may not precisely coincide. While illustrated in FIG. 18 with only two image pairs, if, in certain embodiments, there were N images there would be N−1 image pairings that may include image A and consequently N−1 intersection 3D points that may be mapped out over a desired reference surface or derived reference surface. Considering at least one reference surface (FIG. 18 being an example when considering Reference Plane 750), sets of nearby intersection points constructed substantially on or nearby this surface from different image pairs, may be collected into 3D neighbourhoods. The projections of two such intersection 3D points in an example 3D neighbourhood shown by circle 1811. Note that example neighbourhood 1811 may be any suitable shape, and only indicated here as a circle for pedagogical convenience. If there were more images available, additional intersection points may be added to one or more 3D neighbourhoods. For example, choosing 4 images may enable 3 such intersection points to be collected into substantially each of the 3D neighbourhoods thus constructed. Choosing 16 images may provide 15 intersection 3D points for inclusion in substantially each of the 3D neighbourhoods.

In certain embodiments, 3D neighbourhoods may be determined by a fixed division of a reference plane into squares, hexagons or other suitable shapes.

In certain embodiments, the projection from 3D neighbourhoods to pixels in the image data or one or more image pairs, may be pre-computed. In certain embodiments, the mapping may be retrieved by querying a suitable data structure such as a lookup table.

The proximity of the intersection 3D points in 3D neighbourhoods means that their collective associated spectral data and/or optical flow data may be used to assess the likelihood that a physical surface may be present at a 3D location representative of the 3D neighbourhood i.e., the more consistent the spectral data and/or the optical flow data amongst the projections of the 3D points in the 3D neighbourhood, the more likely a physical surface exists at or passes through the 3D neighbourhood.

To build the cost matrix 1400, columns of the cost matrix may be considered in turn. Starting with a cost matrix element in the first layer 1410, say element 1411, for the intersection 3D points in the 3D neighbourhood associated with this cost matrix element, the associated image pixel data, optical flow data and/or other associated data may be retrieved. In certain embodiments, the representative 3D point may be a digital representation of the location of an actual 3D point in a scene as well as none or some of the retrieved data associated with that 3D point. In certain embodiments, the representative 3D neighbourhood may be a digital representation of a 3D neighbourhood in a scene as well as none or some of the retrieved data associated with that 3D neighbourhood. The selection of these data may be assisted by using a look-up table precomputed from geometric considerations of the viewpoints and locations from which the images were taken and the 3D neighbourhood in question. This collected data may form a representative 3D neighbourhood which may then be associated with the cost matrix element. From this representative 3D neighbourhood, a cost value may be determined as is described elsewhere and stored with the associated element of the cost matrix. Additional information may be extracted or processed from that available in the representative 3D neighbourhood and may also be stored with the associated element of the cost matrix for convenient reference in subsequent processing. Non-limiting examples of such additional data may be summarised spectral and/or 3D velocity information that characterises the 3D points in the 3D neighbourhood.

Following the determination of a cost value for element 1411 in the first layer (1410) of the cost matrix, the next element in the column of cost elements may be determined. Given the same image pairs and same initial location of the image pixel data as was used for the cost matrix element in the top layer, subsequent cost matrix elements in the same column of the cost matrix may be determined by adjusting the first pixel location along the scanline of the first rectified image or the second pixel location along the scanline of the second rectified image, according to the desired cost matrix element which in turn may be associated with a particular 3D neighbourhood in the scene. Repeating this process of scanline adjustments for additional image pairs produces representative 3D intersection points around which representative 3D neighbourhoods may be formed, a cost value may be calculated, and at least a portion, or at least a substantial portion, of the results may be stored with element 1412 in the cost matrix 1400 on layer 1420. This process may be repeated to determine representative 3D neighbourhoods and cost values for a substantial portion of the elements in the cost matrix 1400.

In certain embodiments, the data from the representative 3D neighbourhood used for the computation of the cost value may include spectral data (for example, pixel data, luminance data, colour data, data as RGB components, and/or data as YUV components) and/or pixel optical flow data (for example, one or more of the following: apparent local instantaneous vertical image motion and apparent local instantaneous horizontal image motion). In certain embodiments, the computation of the cost value may depend on a weighting to be applied to at least some of the data associated with the 3D points in the neighbourhood. In certain embodiments, the weighting may be based on the distance between 3D points in the neighbourhood and a selected or computed 3D reference point that may be associated with the 3D neighbourhood (non-limiting examples of such a 3D reference point are the 3D mean or geometric median of the 3D points in the neighbourhood, or the centroid of the 3D neighbourhood). In certain embodiments, the velocity in one, two or three dimensions may be used in the determination of a cost value. In certain embodiments, the computation to determine the cost may be one or more of the following operations performed on the collective data in the representative 3D neighbourhood: a linear combination, a nonlinear computation, using pre-computed look-up table(s) to return a value, and using neural networks. In certain embodiments, the computation to determine the cost in matrix elements may, in addition to the data of the representative 3D neighbourhood associated with it, consider the data of representative 3D neighbourhoods associated with neighbouring matrix elements.

The cost values, written into the elements of the cost matrix may represent a nominal cost for assuming there is a physical surface present in the scene at the 3D location of the 3D neighbourhood associated with that element. In certain embodiments, the cost value may be a numeric value greater or equal to zero.

To compute the cost matrix efficiently (i.e., minimal computational operations), it may be useful to ensure the reference surfaces and derived reference surfaces from different image pairs are substantially aligned.

From geometric principles it may be seen that 3D neighbourhoods of minimal extent may be constructed based on a mapping that records across a single reference surface (for example 750) a single offset per location (for example the shift from 1821 to 1831) if the reference surface and derived reference surfaces (750, 751, 752, 753 and so forth) are common to substantially all image pairs whose intersection points (e.g., FIG. 7, A: 760, 761, 762, 763, 764, 770, 771, 772, 773, 780, 781, 782 etc) may be included in the 3D neighbourhoods and which thereby form the basis of sets of data associated with 3D neighbourhoods that may be then used to compute the values in the corresponding elements of the cost matrix. There may be advantages to arranging the intersection points in a portion of 3D neighbourhoods in this manner, as a computing device may then be able to retrieve the necessary data from rectified images with fewer accesses to digital memory, and may consequently be able to compute the representative 3D neighbourhoods that form the cost matrix more efficiently because fewer operations may be needed. The geometric constructions disclosed herein that permit data for representative 3D neighbourhoods, and thereby cost matrix entries, to be extracted from rectified images using substantially constant offsets may further permit computing devices to calculate the cost matrix entries with fewer operations and/or accesses to digital memory, and therefore complete the cost matrix values more quickly or efficiently. In certain embodiments, the data associated with intersection points that are input into the likelihood calculations for the one or more 3D neighbourhoods that are associated with 3D scene information substantially aligned on at least one reference surface is calculated from the associated pixel data extracted from at least two rectified images may be separated by a pixel offset. In certain embodiments, the pixel offset may be constant or substantially constant. In certain embodiments, a portion of the pixel offsets may be constant or substantially constant. In certain embodiments, a substantial portion of the pixel offsets may be constant or substantially constant.

Without the rectification processes disclosed herein, extracting pixel data from multiple cameras that represent light emanating from selected 3D neighbourhoods in the physical scene in order to calculate entries in a cost matrix may require, because of the unconstrained geometric positioning and/or movement of the cameras, unique calculations for each image pair and for each cost matrix element. If these calculations were at least a linear combination of raw pixel data with a set of tailored parameters, the number of operations a computing device might have to perform for each cost matrix element might be N (the number of cameras in the system) times larger, and the number of accesses to digital memory D (the number of planes in the cost matrix stack) times larger than when using the method outlined in this disclosure. For example, a system configured to process 4 images and 1000 candidate depth planes in its cost matrix may require 4 times more operations and 1000 times more memory accesses; potentially resulting in significantly slower operation. Using the one or more of the rectification processes disclosed herein, the number of operations and/or the number of memory accesses may be reduced.

Notwithstanding the above advantages, in certain embodiments, it may be beneficial to base rectifications and neighbourhood construction around a common reference surface (for example 750), but to determine the derived reference surfaces 751, 752, 753 and so forth independently for one or more image pairs. In certain embodiments, instead of being fixed the surfaces' spacing may be varied for one or more image pairs to achieve a desired spatial resolution across pairs of rectified images. In certain embodiments, the spatial resolution of the consistent depth shift images may be at least 100, 200, 400, 800, 1000, 1500, 2000, 4000, 8000, or 16000 samples. In certain embodiments, there may be an efficient mapping between the rectified image data based upon the independently selected reference surfaces and the rectified image data based upon the common reference surfaces. In certain embodiments, this mapping may be incorporated into step Build Cost Matrix 1380 (and also step Perform Optical Flow 1370 if used) by storing rectified image data based on the independently selected reference surfaces in a suitable associated data structure. In some embodiments, storing the rectified image data based on the independently selected reference surfaces may have the advantage of permitting a more accurate computation of the rectified image data than if based upon the common reference surfaces, but without undue additional computational cost.

Following the step Build Cost Matrix 1380, flow proceeds to the step Generate 3D Scene Information 1390. At Generate 3D Scene Information 1390 the cost matrix built in the previous steps may be used to determine 3D Scene Information which may be stored in a 3D Information data structure.

The 3D Information may be calculated by optimally computing a minimal total cost path along a series of linear directions using (one dimensional) dynamic programming methods, for example 1-D dynamic time warping or 1-D scanline optimization. The linear directions may be those substantially aligned along vertical slices of columns of the cost matrix (an example column in FIG. 14 is the stack of cost matrix elements 1411, 1412, 1413, 1414) and the resulting optimal cost path may consist of the representative 3D neighbourhoods associated with those elements chosen to be in the path. The physical 3D neighbourhoods identified by the resulting optimal cost path may be straight, substantially straight, curved, continuous, discontinuous, substantially continuous, substantially discontinuous or combinations thereof of a line (for example, a string or ribbon like appearance) substantially following the contours of at least one physical surface in the scene.

In some embodiments, such a path with the optimal total cost may comprise a collected set of representative 3D neighbourhoods that are most likely to represent a path along a physical surface in the scene, and thereby reveal more accurate depth estimates than by considering substantially each representative 3D neighbourhood in isolation.

In some embodiments, optimisations performed along planes of cost matrices substantially aligned to one or more of the epipolar planes (of those available as a consequence of the set of image pairs chosen) may provide more accurate representations of physical surfaces than optimal paths constructed from cost matrices not such aligned. One explanation may be that, except for cases of occlusion in the scene, corresponding pixels in an image pair of positions on physical surfaces in the scene may be found along epipolar lines. As a consequence, for example, with at least one contribution amongst the collected data for a representative 3D neighbourhood being from a physical surface, the path along the epipolar plane that includes this 3D neighbourhood may be more likely to be identified as the optimal one.

In some embodiments, the computational effort of calculating the cost matrix values may be greater than the computational effort of performing linear depth optimisations, and so it may be useful to extract more accurate depth estimates by performing optimisations along multiple directions and exploit the fact that in a substantial number of such optimal path calculations the cost matrix values may be reused and not recalculated if the cost matrix values are calculated in a manner that is independent of the order in which the data in the associated representative 3D neighbourhood is examined. In some embodiments, the multiple lines may align to one or more of the epipolar lines that correspond to one or more of the image pairs chosen.

In some embodiments, the combination of a plurality of depth estimates produced by multiple optimal path computations may facilitate more accurate depth estimates than one such optimal path calculation. For example, by allowing the use of robust statistical measures to produce a refined depth value from the set of depth values produced by the at least one optimal path calculation.

Howsoever derived the depths for at least a substantial portion of the locations may be written into a 3D information data structure together with additional associated data which may include summarized spectral and/or velocity information.

In certain embodiments, the 3D information data structure may be arranged as a depth map having a 2D grid of elements substantially each representing a portion of the scene projected into a view. These elements may store depth, and may additionally store spectral data, optical flow data, and/or other data associated with that portion of the scene. In certain embodiments, the 3D information data structure may be arranged as a point cloud: i.e., a set of 3D points that collectively represent an approximation to the physical surfaces or objects in a scene. The 3D points in the point cloud may additionally contain associated spectral data, optical flow data, and/or other data.

The 3D scene information data structure, or the information it contains, may be output from the computer system 115 to external systems by the communication bus 181 (FIG. 1).

Following Generate 3D Scene Information 1390 flow proceeds to back to step Get Images 1330 where the process may continue in a loop for an extended period of time or until it is shutdown or otherwise interrupted. Thus, by repeating steps from 1330 to 1390 a stream of 3D Scene Information may be output.

Exemplary Process—Alternative without Optical Flow

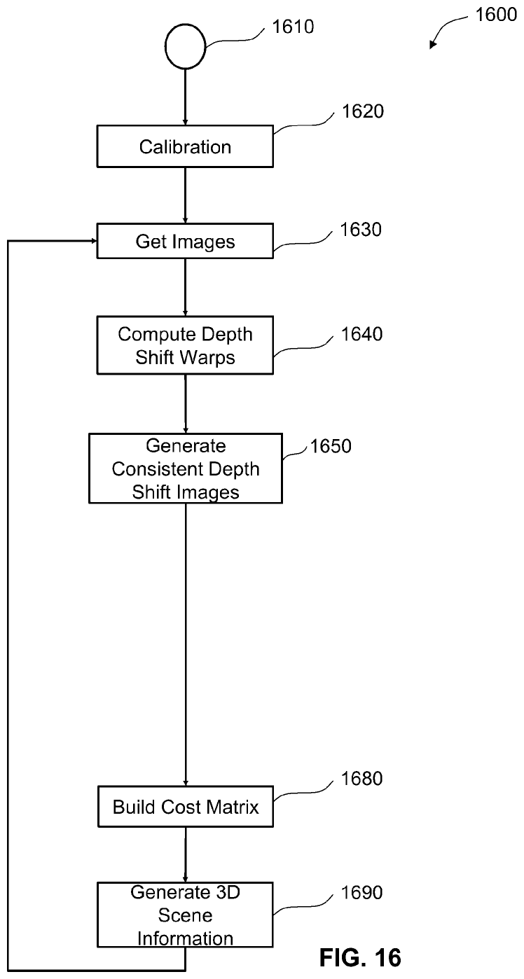

In certain embodiments, 3D Scene Information may be generated without use of optical flow data. Referring to FIG. 16 and flow chart 1600 processing starts at 1610. The steps 1620, 1630 and 1640 are as described in the Exemplary Process and FIG. 13 respectively as 1320, 1330 and 1340 and will not be described further.

The operation of step Generate Consistent Depth Shift Images 1660 is as described with respect to step 1360 (FIG. 13) excepting that the images processed may not contain optical flow data. From step 1660 flow proceeds to step Build Cost Matrix 1380.

The operation of step Build Cost Matrix 1680 is as described with respect to step 1380 (FIG. 13) excepting that optical flow data may not be used in building the cost matrix, so, for example, the cost values may not have contributions from optical flow data including derived information such as vertical pixel motion. From step Build Cost Matrix 1680 flow proceeds to step Generate 3D Scene Information 1690.

The operation of step Generate 3D Scene Information 1690 may be described with respect to step Generate 3D Scene Information 1380 (FIG. 13) excepting that optical flow data may not be used to determine 3D velocity data. From step Generate 3D Scene Information 1690 flow passes again to Get Images 1640.

Exemplary Process—Optical Flow Performed after Image Warping

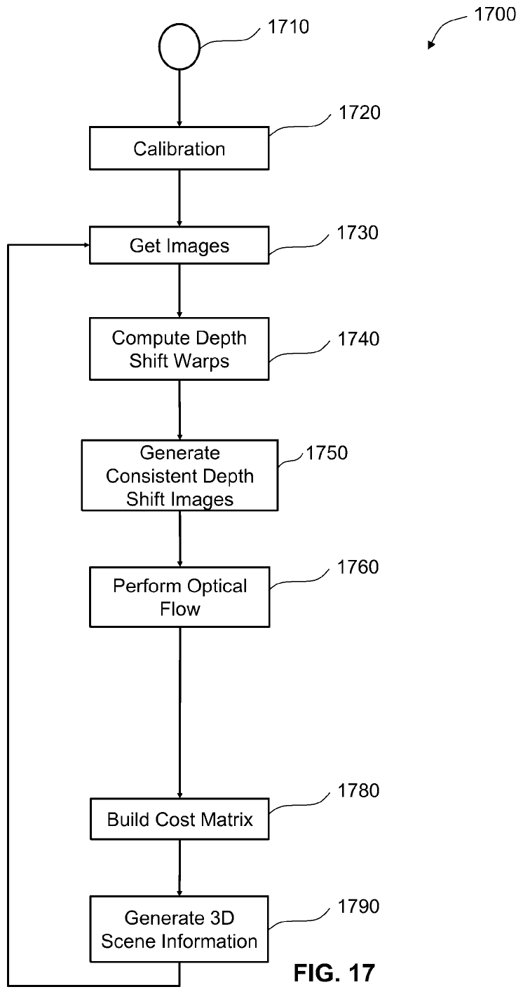

In certain embodiments, optical flow processing may be performed following image warping. Referring to FIG. 17 and flow chart 1700 processing starts at 1710. The steps 1620, 1630 and 1640 are as described in the Exemplary Process and FIG. 13 respectively as 1320, 1330, and 1340 and will not be described further. From step Get Images 1740 flow proceeds to Generate Consistent Depth Shift Images 1760.

The operation of step Generate Consistent Depth Shift Images 1750 is as described with respect to step Generate Consistent Depth Shift Images 1360 (FIG. 13) excepting that the images processed may not contain optical flow data. From step 1750 flow proceeds to step Perform Optical Flow 1760.

The operation of step Perform Optical Flow 1760 may be as described with respect to step 1380 (FIG. 13) excepting that optical flow may be performed on the Consistent Depth Shift Images (i.e., rectified images) arising from the previous step, thus optical flow may be used to determine the local apparent movement of the rectified image appearance. From step Perform Optical Flow 1760 flow proceeds to step Build Cost Matrix 1780.

The steps 1780 and 1790 are as described in the Exemplary Process and FIG. 13 and will not be described further.

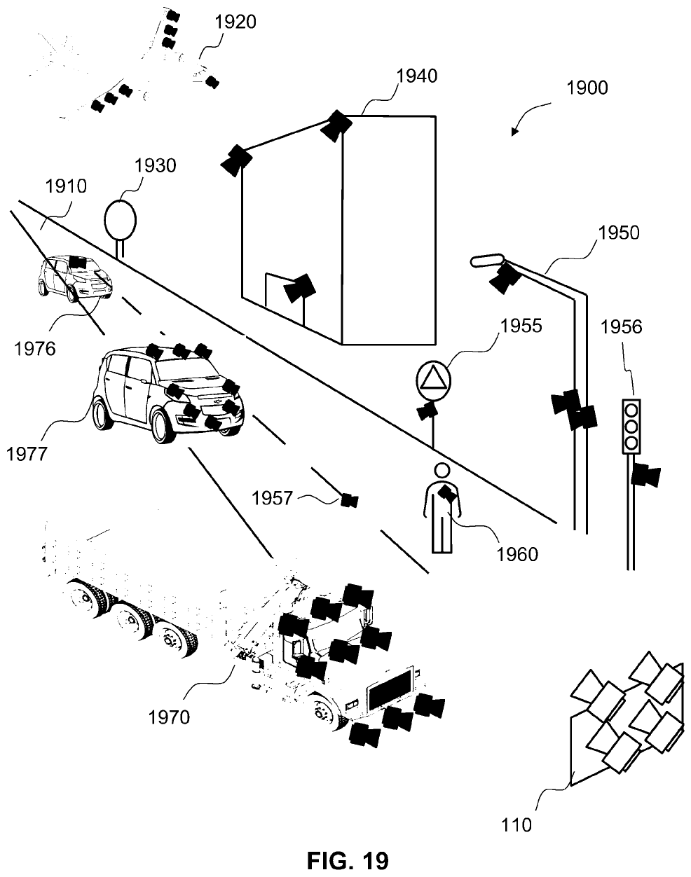

A range of alternative camera positions are illustrated in FIG. 19, where one or more cameras are shown on moving platforms (for example, the cars 1976 and 1977, truck 1970, plane 1920 or the person 1960) and one or more other cameras are shown mounted on static objects in the scene (for example, the building 1940, signpost 1955, streetlight 1950, traffic light 1956, road-level element or cat's-eye 1957). Using suitable digital communication mechanisms at least a portion, or at least a substantial portion, of these cameras, mounted on one or more moving or stationary objects, may contribute to a system configured to determine 3D scene information according to certain embodiments.

Further advantages of the claimed subject matter will become apparent from the following examples describing certain embodiments of the claimed subject matter.

1A. A system for generating three-dimensional information of a scene comprising: one or more cameras, the one or more cameras configured to be positioned to view the scene, and the one or more cameras configured to generate pixel data representative of at least two images taken at different positions relative to the scene;
the one or more cameras configured to transmit pixel data associated at least in part with at least two images to one or more computer systems; and
the one or more computer systems configured to:
obtain the associated pixel data from the at least two images; and
use at least a portion of the associated pixel data to determine the likely position of one or more physical surfaces in the scene.

2A. A system for generating three-dimensional information of a scene comprising: one or more cameras, the one or more cameras configured to be positioned to view the scene, and the one or more cameras configured to generate pixel data representative of at least two images taken at different positions relative to the scene;
the one or more cameras configured to transmit pixel data associated at least in part with the least two images to one or more computer systems; and
the one or more computer systems configured to:
obtain the transmitted associated pixel data from the at least two images;
extract at least a portion of the associated pixel data;
use the at least a portion of the associated pixel data to generate a representation of a 3D neighbourhood that is representative of at least a portion of the scene based at least in part on the projection of the 3D neighbourhood in at least one of the images; and
use the at least a portion of the associated pixel data to determine the likelihood one or more physical surfaces in the scene intersects the 3D neighbourhood.

3A. A system for generating three-dimensional information of a scene comprising:
one or more cameras, the one or more cameras configured to be positioned to view the scene, and the one or more cameras configured to generate pixel data representative of at least two images taken at different positions relative to the scene;
the one or more cameras configured to transmit pixel data associated at least in part with the at least two images to one or more computer systems; and
the one or more computer systems configured to:
obtain the transmitted pixel data;
use at least portion of the pixel data to generate one or more representations of one or more 3D neighbourhoods that are representative of at least in part of a portion of the scene; and
use the one or more representations to determine a likelihood that the one or more 3D neighbourhoods contain at least one physical surface from the scene.

4A. The system of any of the examples 1A to 3A, wherein the one or more computer systems is configured to determine the likelihood that the one or more 3D neighbourhoods contain at least one physical surface from the scene.

5A. The system of any of the examples 1A to 4A, wherein the one or more computer systems is configured to extract at least a portion of the associated pixel data.

6A. The system of any of the examples 1A to 5A, wherein the one or more computer systems is configured to use the at least a portion of the associated pixel data to generate one or more representative 3D neighbourhoods that are representative of at least a portion of the scene and based at least in part on the projection of the one or more 3D neighbourhoods in at least one of the images.

7A. The system of any of the examples 1A to 6A, wherein the one or more computer systems is configured to use the at least a portion of the associated pixel data to generate one or more representative 3D neighbourhoods that are representative of at least a portion of the scene and based at least in part on the pixel data comprising the projection of the one or more 3D neighbourhoods in at least one of the images.

8A. The system of any of the examples 1A to 7A, wherein the one or more computer systems is configured to use at least a portion of the associated pixel data comprising the projections into the at least two images of the one or more 3D neighbourhoods that are representative of at least a portion of the scene.

9A. The system of any of the examples 1A or 8A, wherein the at least a portion of the associated pixel data of the one or more 3D neighbourhoods includes one or more of the following: spectral data and spectral data characteristic of a substantive physical surface.

10A. The system of any of the examples 1A or 9A, wherein the at least a portion of the associated pixel data includes optical flow information.

11A. The system of any of the examples 1A or 10A, wherein the at least a portion of the associated pixel data includes pixel-level spectral data and/or pixel-level optical flow information derived from the projection of a 3D neighbourhood in at least one of the camera images.

12A. The system of any of the examples 1A to 11A, wherein the one or more computer systems is configured to use at least a substantial portion of the at least a portion of the associated pixel data to determine an estimated velocity for the one or more physical surfaces in at least one of the three potential dimensions of space relative to the one or more cameras.

13A. The system of any of the examples 1A to 12A, wherein the one or more cameras configured to generate pixel data representative of at least three images taken at different positions relative to the scene and the at least a portion of the associated pixel data is a subset of the pixel data determined by the projection of the one or more 3D neighbourhoods in at least one of the camera images.

14A. The system of any of the examples 1A to 13A, wherein the one or more cameras configured to generate pixel data representative of at least four images taken at different positions relative to the scene and the at least a portion of the associated pixel data is a subset of the pixel data determined by the projection of the one or more 3D neighbourhoods in at least one of the camera images.

15A. The system of examples 11A or 14A, wherein the at least four images or at least three images are taken at different positions relative to the scene within a relatively static time period.

16A. The system of any of the examples 1A to 15A, wherein the at least a portion of the associated pixel data is a subset of the pixel data determined by the projection of the at least one of the one or more 3D neighbourhoods into at least one of the images.

17A. The system of any of the examples 1A to 16A, wherein the at least a portion of the associated pixel data is weighted by the 2D distances between two or more pixel locations when projected onto a representative two-dimensional surface.

18A. The system of any of the examples 1A to 17A, wherein the at least a portion of the associated pixel data is weighted by the 2D distances between two or more pixel locations when projected onto at least one of the image planes associated with at least one of the images.

19A. The system of any of the examples 1A to 18A, wherein at least one representative 3D point is selected from the representative 3D neighbourhood and the weighting placed on the at least a portion of the associated pixel data is at least partially dependent on the proximity of at least one pixel location to the projection of the at least one representative 3D point onto a representative two-dimensional surface.

20A. The system of any of the examples 1A to 19A, wherein at least one representative 3D point is weighted by the distance between the at least one representative 3D point and a selected reference representative 3D point after both 3D points are projected onto a representative two-dimensional surface.

21A. The system of any of the examples 1A to 20A, wherein at least one representative 3D point is weighted by the distance between the at least one representative 3D point and a selected reference representative 3D point after both 3D points are projected into the 3D physical scene to their estimated depths in the scene.

22A. The system of any of the examples 1A to 21A, wherein no two 3D neighbourhoods overlap.

23A. The system of any of the examples 1A to 22A, wherein a substantial portion of the 3D neighbourhoods do not overlap.

24A. The system of any of the examples 1A to 23A, wherein the 3D neighbourhoods in aggregate cover the entire scene.

25A. The system of any of the examples 1A to 24A, wherein the multiple 3D neighbourhoods in aggregate do not cover the entire scene.

26A. The system of any of the examples 1A to 25A, wherein the multiple 3D neighbourhoods are substantially centred or substantially aligned along at least one line projecting into the scene from at least one fixed 3D point relative to the 3D position of the camera centres at the time, or times, the camera or cameras captured the images.

27A. The system of any of the examples 1A to 26A, wherein at least a portion of the multiple 3D neighbourhoods are substantially centred along at least one line projecting into the scene from at least one 3D point fixed relative to the 3D position of the camera centres at the time, or times, the camera or cameras captured the images.

28A. The system of any of the examples 1A to 27A, wherein at least a portion of the multiple 3D neighbourhoods are substantially aligned along at least one line projecting into the scene from at least one 3D point fixed relative to the 3D position of the camera centres at the time, or times, the camera or cameras captured the images.

29A. The system of any of the examples 1A to 28A, wherein at least a portion of the multiple 3D neighbourhoods are substantially centred along a plurality of lines projecting into the scene from at least one 3D point fixed relative to the 3D position of the camera centres at the time, or times, the camera or cameras captured the images.

30A. The system of any of the examples 1A to 29A, wherein at least a portion of the multiple 3D neighbourhoods are substantially aligned along the plurality of lines projecting into the scene from at least one 3D point fixed relative to the 3D position of the camera centres at the time, or times, the camera or cameras captured the images.

31A. The system of any of the examples 1A to 30A, wherein data collected from within at least a portion of the multiple 3D neighbourhoods is used to determine the likelihood that the physical surface is at least partially contained within the one or more 3D neighbourhoods.

32A. The system of any of the examples 1A to 31A, wherein the portion of the multiple 3D neighbourhoods is representative of a line passing through the scene.

33A. The system of any of the examples 1A to 32A, wherein the line is straight, substantially straight, curved, continuous, discontinuous, substantially continuous, substantially discontinuous or combinations thereof and substantially follows the contours of at least one physical surface in the scene.

34A. The system of any of the examples 1A to 33A, wherein the line has a string like or ribbon like shape substantially following the contours of at least one physical surface in the scene.

35A. The system of any of the examples 1A to 34A, wherein cost matrix values are used in an optimization calculation to obtain an optimized cost path comprised of the set of 3D neighbourhoods most likely to contain physical surfaces.

36A. The system of any of the examples 1A to 35A, wherein already calculated likelihood calculations within a cost matrix are used at least in part for defining subsequent cost matrices whose columns are substantially aligned with at least one other line across at least one image.

37A. A system of any of the examples 1A to 36A, wherein likelihood calculations within a portion of 3D neighbourhoods produce numeric results that are independent of an order in which at least a portion of the data from intersection points derived from the set of image pairs is processed.

38A. The system of any of the examples 1A to 37A, wherein the optimization calculation is repeated for a plurality of lines derived from the selected image pairs.

39A. The system any of the examples 1A to 38A, wherein the plurality of lines is selected from epipolar lines.

40A. The system any of the examples 1A to 39A, wherein a portion of the plurality of lines is selected from epipolar lines.

41A. The system of any of the examples 1A to 40A, wherein the data associated with intersection points that are input into the likelihood calculations for the one or more 3D neighbourhoods that are associated with 3D scene information substantially aligned on at least one reference surface is calculated from the associated pixel data extracted from at least two rectified images separated by a pixel offset.

42A. The system of any of the examples 1A to 41A, wherein the pixel offset is constant.

43A. The system of any of the examples 1A to 42A, wherein the pixel offset is substantially constant.

44A. The system of any of the examples 1A to 43A, wherein the pixel offset is not constant.

45A. A system of any of the examples 1A to 44A, wherein the pixel offset is not substantially constant.

46A. The system of any of the examples 1A to 45A, wherein a portion of the pixel offsets are constant.

47A. The system of any of the examples 1A to 46A, wherein a portion of the pixel offsets are substantially constant.

48A. The system of any of the examples 1A to 47A, wherein a portion of the pixel offsets are not constant.

49A. The system of any of the examples 1A to 48A, wherein a portion of the pixel offsets are not substantially constant.

50A. The system of any of the examples 1A to 49A, wherein a substantial portion of the pixel offsets are constant.

51A. The system of any of the examples 1A to 50A, wherein a substantial portion of the pixel offsets are substantially constant.

52A. The system of any of the examples 1A to 51A, wherein a substantial portion of the pixel offsets are not constant.

53A. The system of any of the examples 1A to 52A, wherein a substantial portion of the pixel offsets are not substantially constant.

54A. The system of any of the examples 1A to 53A, wherein the system is calibrated before operation of the system.

55A. The system of any of the examples 1A to 54A, wherein the system is configured to calibrated during operation of the system.

56A. The system of any of the examples 1A to 55A, wherein at least one camera is calibrated with respect to one or more intrinsic camera parameters, one or more extrinsic camera parameters, or combinations thereof.

57A. The system of any of the examples 1A to 56A, wherein the one or more intrinsic camera parameters include one or more of the following: the field of view, focal length, the image centre, compensation for radial lens distortion, and other distortions.

58A. The system of any of the examples 1A to 57A, wherein one or more extrinsic camera parameters include one or more of the following: camera location and camera orientation in space with respect to a designated frame of reference.

59A. The system of any of the examples 1A to 58A, wherein the one or more cameras comprises a plurality of cameras.

60A. The system of any of the examples 1A to 59A, wherein the one or more cameras are not arranged so that their camera centres are substantially coplanar.

61A. The system of any of the examples 1A to 60A, wherein the one or more cameras are not arranged so that their camera centres are substantially colinear.

62A. The system of any of the examples 1A to 61A, wherein the one or more cameras are arranged in one or more planes.

63A. The system of any of the examples 1A to 62A, wherein at least one of the one or more cameras produces image data that represents the scene with different spectral bands from other cameras in the one or more cameras.

64A. The system of any of the examples 1A to 63A, wherein the systems is configured to generate three-dimensional information in real-time.

65A. The system of any of the examples 1A to 64A, wherein the systems is configured to generate three-dimensional information at real-time frame rates.

66A. The system of any of the examples 1A to 65A, wherein the one or more cameras are associated with a mobile platform or vehicle.

67A. The system of any of the examples 1A to 66A, wherein at least one camera of the one or more cameras is associated with the mobile platform or vehicle that is configured to be mobile and at least one other camera of the one or more cameras is associated with a stationary platform and is configured to be stationary.

68A. The system of any of the examples 1A to 67A, wherein at least one camera of the one or more cameras is configured to be mobile and at least one other camera of the one or more cameras is configured to be stationary.

69A. The system of any of the examples 1A to 68A, wherein the one or more computer systems is configured to determine an estimated velocity for the physical surface of at least a portion of the one or more 3D neighbourhoods in at least one of the three potential dimensions of space relative to the one or more cameras.

70A. A system that is configured to determine the presence of one or more surfaces in the scene by processing multiple 3D neighbourhoods using any of the systems in examples 1A to 69A to determine the likelihood of a surface within at least one 3D neighbourhood, and collect at least a portion of these results into an accumulated dataset.

71A. A method for generating three-dimensional video information of the scene using any of the systems in examples 1A to 69A.

72A. A method for generating three-dimensional models of the scene using any of the systems in examples 1A to 69A.

73A. One or more computer-readable non-transitory storage media embodying software that is operable when executed to operate any of the systems of examples 1A to 69A.

74A. A system comprising: one or more processors; and one or more memories coupled to the one or more processors comprising instructions executable by the one or more processors, the one or more processors being operable when executing the instructions to operate any of the systems of examples 1A to 69A.

Any description of prior art documents herein, or statements herein derived from or based on those documents, is not an admission that the documents or derived statements are part of the common general knowledge of the relevant art.

1B. A method for generating three-dimensional information of a scene comprising:
generating at least two images taken at different positions relative to the scene with one or more cameras, the one or more cameras positioned to view the scene, and generating pixel data representative of the at least two images taken at different positions relative to the scene with the one or more cameras;
transmitting pixel data associated at least in part with the at least two images from the one or more cameras to one or more computer systems;
receiving at the one or more computer systems the associated pixel data from the at least two images; and
using at least a portion of the associated pixel data to determine the likely position of one or more physical surfaces in the scene.

2B. A method for generating three-dimensional information of a scene comprising:
generating pixel data representative of at least two images taken at different positions relative to the scene with one or more cameras, the one or more cameras being positioned to view the scene;
transmiting pixel data associated at least in part with the least two images from the one or more cameras to one or more computer systems;
obtaining the transmitted associated pixel data from the at least two images at the one or more computer systems;
extracting at least a portion of the associated pixel data at the one or more computer systems;
using the at least a portion of the associated pixel data to generate a representation of a 3D neighbourhood that is representative of at least a portion of the scene based at least in part on the projection of the 3D neighbourhood in at least one of the images; and
using the at least a portion of the associated pixel data to determine the likelihood one or more physical surfaces in the scene intersects the 3D neighbourhood.

3B. A method for generating three-dimensional information of a scene comprising:
generating pixel data representative of at least two images taken at different positions relative to the scene with one or more cameras, the one or more cameras being positioned to view the scene;
transmitting pixel data associated at least in part with the at least two images from the one or more cameras to one or more computer systems;
obtaining the transmitted pixel data at the one or more computer systems;
using at least portion of the pixel data to generate one or more representations of one or more 3D neighbourhoods that are representative of at least in part of a portion of the scene; and
using the one or more representations to determine a likelihood that the one or more 3D neighbourhoods contain at least one physical surface from the scene.

4B. The method of any of the examples 1B to 3B, wherein the at least a portion of the associated pixel data of the one or more 3D neighbourhoods includes one or more of the following: spectral data and spectral data characteristic of a substantive physical surface.

5B. The method of any of the examples 1B or 4B, wherein the at least a portion of the associated pixel data includes optical flow information.

6B. The method of any of the examples 1B or 5B, wherein the at least a portion of the associated pixel data includes pixel-level spectral data and/or pixel-level optical flow information derived from the projection of a 3D neighbourhood in at least one of the camera images.

7B. The method of any of the examples 1B to 6B, wherein the one or more computer systems uses at least a substantial portion of the at least a portion of the associated pixel data to determine an estimated velocity for the one or more physical surfaces in at least one of the three potential dimensions of space relative to the one or more cameras.

8B. The method of any of the examples 1B to 7B, wherein the one or more cameras generate pixel data representative of at least three images taken at different positions relative to the scene and the at least a portion of the associated pixel data is a subset of the pixel data determined by the projection of the one or more 3D neighbourhoods in at least one of the camera images.

9B. The method of any of the examples 1B to 8B, wherein the one or more cameras generate pixel data representative of at least four images taken at different positions relative to the scene and the at least a portion of the associated pixel data is a subset of the pixel data determined by the projection of the one or more 3D neighbourhoods in at least one of the camera images.

10B. The method of examples 8B or 9B, wherein the at least four images or at least three images are taken at different positions relative to the scene within a relatively static time period.

11B. The method of any of the examples 1B to 10B, wherein the multiple 3D neighbourhoods in aggregate do not cover the entire scene.

12B. The method of any of the examples 1B to 11B, wherein the multiple 3D neighbourhoods are substantially centred or substantially aligned along at least one line projecting into the scene from at least one fixed 3D point relative to the 3D position of the camera centres at the time the camera or cameras captured the images.

13B. The method of any of the examples 1B to 12B, wherein data collected from within at least a portion of the multiple 3D neighbourhoods is used to determine the likelihood that the physical surface is at least partially contained within the one or more 3D neighbourhoods.

14B. The method of any of the examples 1B to 13B, wherein the portion of the multiple 3D neighbourhoods is representative of a line passing through the scene.

15B. The method of any of the examples 1B to 14B, wherein the line is straight, substantially straight, curved, continuous, discontinuous, substantially continuous, substantially discontinuous or combinations thereof and substantially follows the contours of at least one physical surface in the scene.

16B. The method of any of the examples 1B to 15B, wherein the line has a string like or ribbon like shape and substantially follows the contours of at least one physical surface in the scene.

17B. The method of any of the examples 1B to 16B, wherein already calculated likelihood calculations within a cost matrix are used at least in part for defining subsequent cost matrices whose columns are substantially aligned with at least one other line across at least one image.

18B. The method of any of the examples 1B to 17B, wherein likelihood calculations within a portion of 3D neighbourhoods produce numeric results that are independent of an order in which at least a portion of the data from intersection points derived from the set of image pairs is processed.

19B. The method of any of the examples 1B to 18B, wherein the optimization calculation is repeated for a plurality of lines derived from the selected image pairs.

20B. The method of any of the examples 1B to 19B, wherein the plurality of lines is selected from epipolar lines.

21B. The method of any of the examples 1B to 20B, wherein a portion of the plurality of lines is selected from epipolar lines.

22B. The method of any of the examples 1B to 21B, wherein the data associated with intersection points that are input into the likelihood calculations for the one or more 3D neighbourhoods that are associated with 3D scene information substantially aligned on at least one reference surface is calculated from the associated pixel data extracted from at least two rectified images separated by a pixel offset.

23B. The method of any of the examples 1B to 22B, wherein the pixel offset is constant.

24B. The method of any of the examples 1B to 23B, wherein the pixel offset is substantially constant.

25B. The method of any of the examples 1B to 24B, wherein a portion of the pixel offsets are constant.

26B. The method of any of the examples 1B to 25B, wherein a portion of the pixel offsets are substantially constant.

27B. The method of any of the examples 1B to 26B, wherein the one or more cameras are not arranged so that their camera centres are substantially coplanar.

28B. The method of any of the examples 1B to 27B, wherein the one or more cameras are not arranged so that their camera centres are substantially colinear.

29B. The method of any of the examples 1B to 28B, wherein the systems is configured to generate three-dimensional information in real-time.

1C. One or more computer-readable non-transitory storage media embodying software that is operable when executed to:
receive associated pixel data from at least two images, wherein the at least two images were taken at different times and at different positions relative to a scene;
extract a portion of the pixel data comprising a projection of a first 3D neighbourhood representative of at least in part a portion of the scene from the at least two images; and
use at least a portion of the extracted pixel data to determine a likelihood that the first 3D neighbourhood contains a representative physical surface associated with the scene.

2C. A system comprising: one or more processors; and one or more memories coupled to the one or more processors comprising instructions executable by the one or more processors, the one or more processors being operable when executing the instructions to:
receive associated pixel data from at least two images, wherein the at least two images were taken at different times and at different positions relative to a scene;
extract a portion of the pixel data comprising a projection of a first 3D neighbourhood representative of at least in part a portion of the scene from the at least two images; and
use at least a portion of the extracted pixel data to determine a likelihood that the first 3D neighbourhood contains a representative physical surface associated with the scene.

While certain embodiments have been shown and described herein, it will be obvious to those skilled in the art that such embodiments are provided by way of example only.

In the foregoing description of certain embodiments, specific terminology has been resorted to for the sake of clarity. However, the disclosure is not intended to be limited to the specific terms so selected, and it is to be understood that a specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It is to be understood that the present disclosure is not limited to the disclosed embodiments, and is intended to cover various modifications and equivalent arrangements included within the spirit and scope of the present disclosure. Also, the various embodiments described above may be implemented in conjunction with other embodiments, e.g., aspects of one embodiment may be combined with aspects of another embodiment to realize yet other embodiments. Further, independent features of a given embodiment may constitute an additional embodiment.

1. A system for generating three-dimensional information of a scene comprising:
one or more cameras, the one or more cameras configured to be positioned to view the scene, and the one or more cameras configured to generate pixel data representative of at least two images taken at different positions relative to the scene;
the one or more cameras configured to transmit pixel data associated at least in part with at least two images to one or more computer systems; and
the one or more computer systems configured to:
obtain the associated pixel data from the at least two images; and
use at least a portion of the associated pixel data to determine the likely position of one or more physical surfaces in the scene.

2. A system for generating three-dimensional information of a scene comprising:
one or more cameras, the one or more cameras configured to be positioned to view the scene, and the one or more cameras configured to generate pixel data representative of at least two images taken at different positions relative to the scene;
the one or more cameras configured to transmit pixel data associated at least in part with the least two images to one or more computer systems; and
the one or more computer systems configured to:
obtain the transmitted associated pixel data from the at least two images;
extract at least a portion of the associated pixel data;
use the at least a portion of the associated pixel data to generate a representation of a 3D neighbourhood that is representative of at least a portion of the scene based at least in part on the projection of the 3D neighbourhood in at least one of the images; and
use the at least a portion of the associated pixel data to determine the likelihood one or more physical surfaces in the scene intersects the 3D neighbourhood.

3. A system for generating three-dimensional information of a scene comprising:
one or more cameras, the one or more cameras configured to be positioned to view the scene, and the one or more cameras configured to generate pixel data representative of at least two images taken at different positions relative to the scene;
the one or more cameras configured to transmit pixel data associated at least in part with the at least two images to one or more computer systems; and
the one or more computer systems configured to:
obtain the transmitted pixel data;
use at least portion of the pixel data to generate one or more representations of one or more 3D neighbourhoods that are representative of at least in part of a portion of the scene; and
use the one or more representations to determine a likelihood that the one or more 3D neighbourhoods contain at least one physical surface from the scene.

4. The system of claim 1, wherein the at least a portion of the associated pixel data of the one or more 3D neighbourhoods includes one or more of the following: spectral data and spectral data characteristic of a substantive physical surface.

5. The system of claim 1, wherein the at least a portion of the associated pixel data includes optical flow information.

6. The system of claim 1, wherein the at least a portion of the associated pixel data includes pixel-level spectral data and/or pixel-level optical flow information derived from the projection of a 3D neighbourhood in at least one of the images.

7. The system of claim 1, wherein the one or more computer systems is configured to use at least a substantial portion of the at least a portion of the associated pixel data to determine an estimated velocity for the one or more physical surfaces in at least one of the three potential dimensions of space relative to the one or more cameras.

8. The system of claim 1, wherein the one or more cameras configured to generate pixel data representative of at least three images taken at different positions relative to the scene and the at least a portion of the associated pixel data is a subset of the pixel data determined by the projection of the one or more 3D neighbourhoods in at least one of the camera images.

9. The system of claim 1, wherein the one or more cameras configured to generate pixel data representative of at least four images taken at different positions relative to the scene and the at least a portion of the associated pixel data is a subset of the pixel data determined by the projection of the one or more 3D neighbourhoods in at least one of the camera-images.

10. The system of claim 9, wherein the at least four images or at least three images are taken at different positions relative to the scene within a relatively static time period.

11. The system of claim 3, wherein the one or more 3D neighbourhoods in aggregate do not cover the entire scene.

12. The system of claim 3, wherein the one or more 3D neighbourhoods are substantially centered or substantially aligned along at least one line projecting into the scene from at least one fixed 3D point relative to the 3D position of the camera centers at the time, or times, the camera or cameras captured the images.

13. The system of claim 3, wherein data collected from within at least a portion of the one or more 3D neighbourhoods is used to determine the likelihood that the physical surface is at least partially contained within the one or more 3D neighbourhoods.

14. The system of claim 3, wherein the portion of the one or more 3D neighbourhoods is representative of a line passing through the scene.

15. The system of claim 14, wherein the line is straight, substantially straight, curved, continuous, discontinuous, substantially continuous, substantially discontinuous or combinations thereof and substantially follows contours of at least one physical surface in the scene.

16. The system of claim 1, wherein the line has a string like or ribbon like shape and substantially follows the contours of at least one physical surface in the scene.

17. The system of claim 1, wherein already calculated likelihood calculations within a cost matrix are used at least in part for defining subsequent cost matrices whose columns are substantially aligned with at least one other line across at least one image.

18. The system of claim 1, wherein likelihood calculations within a portion of 3D neighbourhoods produce numeric results that are independent of an order in which at least a portion of the data from intersection points derived from the set of images is processed.

19. The system of claim 1, wherein an optimization calculation is repeated for a plurality of lines derived from the selected images.

20. The system claim 19, wherein the plurality of lines is selected from epipolar lines.

21. The system claim 19, wherein a portion of the plurality of lines is selected from epipolar lines.

22. The system of claim 3, wherein the data associated with intersection points that are input into the likelihood calculations for the one or more 3D neighbourhoods that are associated with 3D scene information substantially aligned on at least one reference surface is calculated from the associated pixel data extracted from at least two rectified images separated by a pixel offset.

23. The system of claim 1, wherein the pixel offset is constant.

24. The system of claim 1, wherein the pixel offset is substantially constant.

25. The system of claim 1, wherein a portion of the pixel offsets are constant.

26. The system of claim 1, wherein a portion of the pixel offsets are substantially constant.

27. The system of claim 1, wherein the one or more cameras are not arranged so that their camera centers are substantially coplanar.

28. The system of claim 1, wherein the one or more cameras are not arranged so that their camera centers are substantially colinear.

29. The system of claim 1, wherein the system is configured to generate three-dimensional information in real-time.
